(19) United States
(12) Patent Application Publication
(10) Pub. No.: US 2025/0200787 A1
(43) Pub. Date: Jun. 19, 2025

(54) MACHINE-LEARNING ALGORITHMS FOR LOW-POWER APPLICATIONS

(71) Applicant: SoftEye, Inc., San Diego, CA (US)

(72) Inventors: Edwin Chongwoo Park, San Diego, CA (US); Yong James Lee, San Diego, CA (US)

(73) Assignee: SoftEye, Inc., San Diego, CA (US)

(21) Appl. No.: 18/983,169

(22) Filed: Dec. 16, 2024

Related U.S. Application Data
(60) Provisional application No. 63/610,195, filed on Dec. 14, 2023.

(51) Int. Cl. G06T 7/70; G06F 3/01; G06V 10/764

(52) U.S. Cl. CPC G06T 7/70; G06F 3/013; G06V 10/764; G06V 2201/07

(57) ABSTRACT

Systems, computer programs, devices, and methods that enable ML-based vision processing for low-power, embedded, and/or real-time applications. In one exemplary embodiment, smart glasses use classifiers that are based on machine-learned (ML) patch relationships. The ML patch features are determined during an offline training process. The ML patch features are grouped into weak classifiers, strong classifiers, and detectors to progressively improve prediction accuracy. An object detection architecture uses triggering logic, search management, and a classification neural network to enable event-based searching, interest-based searching, and/or dynamic search control. In some cases, pre-processing may also be used to minimize the neural network complexity (e.g., pre-processing for scaling, rotations, translations, etc.).

### PRIORITY

This application claims the benefit of priority to U.S. Provisional Patent Application Ser. No. 63/610,195 filed Dec. 14, 2023 and entitled “MACHINE-LEARNING ALGORITHMS FOR LOW-POWER APPLICATIONS”, incorporated by reference in its entirety.

### RELATED APPLICATIONS

This application is related to U.S. patent application Ser. No. 18/061,203 filed Dec. 2, 2022, and entitled “SYSTEMS, APPARATUS, AND METHODS FOR GESTURE-BASED AUGMENTED REALITY, EXTENDED REALITY”, U.S. patent application Ser. No. 18/061,226 filed Dec. 2, 2022, and entitled “SYSTEMS, APPARATUS, AND METHODS FOR GESTURE-BASED AUGMENTED REALITY, EXTENDED REALITY”, U.S. patent application Ser. No. 18/061,257 filed Dec. 2, 2022, and entitled “SYSTEMS, APPARATUS, AND METHODS FOR GESTURE-BASED AUGMENTED REALITY, EXTENDED REALITY”, U.S. patent application Ser. No. 18/185,362 filed Mar. 16, 2023, and entitled “APPARATUS AND METHODS FOR AUGMENTING VISION WITH REGION-OF-INTEREST BASED PROCESSING”, U.S. patent application Ser. No. 18/185,364 filed Mar. 16, 2023, and entitled “APPARATUS AND METHODS FOR AUGMENTING VISION WITH REGION-OF-INTEREST BASED PROCESSING”, U.S. patent application Ser. No. 18/185,366 filed Mar. 16, 2023, and entitled “APPARATUS AND METHODS FOR AUGMENTING VISION WITH REGION-OF-INTEREST BASED PROCESSING”, U.S. patent application Ser. No. 18/316,181 filed May 11, 2023, and entitled “METHODS AND APPARATUS FOR SCALABLE PROCESSING”, U.S. patent application Ser. No. 18/316,214 filed May 11, 2023, and entitled “METHODS AND APPARATUS FOR SCALABLE PROCESSING”, U.S. patent application Ser. No. 18/316,206 filed May 11, 2023, and entitled “METHODS AND APPARATUS FOR SCALABLE PROCESSING”, U.S. patent application Ser. No. 18/316,218 filed May 11, 2023, and entitled “APPLICATIONS FOR ANAMORPHIC LENSES”, U.S. patent application Ser. No. 18/316,221 filed May 11, 2023, and entitled “APPLICATIONS FOR ANAMORPHIC LENSES”, U.S. patent application Ser. No. 18/316,225 filed May 11, 2023, and entitled “APPLICATIONS FOR ANAMORPHIC LENSES”, U.S. patent application Ser. No. 18/316,203 filed May 11, 2023, and entitled “APPLICATIONS FOR ANAMORPHIC LENSES”, U.S. patent application Ser. No. 18/745,027 filed Jun. 17, 2024, and entitled “NETWORK INFRASTRUCTURE FOR USER-SPECIFIC GENERATIVE INTELLIGENCE”, U.S. patent application Ser. No. 18/745,233 filed Jun. 17, 2024, and entitled “NETWORK INFRASTRUCTURE FOR USER-SPECIFIC GENERATIVE INTELLIGENCE”, U.S. patent application Ser. No. 18/745,353 filed Jun. 17, 2024, and entitled “NETWORK INFRASTRUCTURE FOR USER-SPECIFIC GENERATIVE INTELLIGENCE”, U.S. patent application Ser. No. 18/745,462 filed Jun. 17, 2024, and entitled “NETWORK INFRASTRUCTURE FOR USER-SPECIFIC GENERATIVE INTELLIGENCE”, U.S. patent application Ser. No. 18/745,779 filed Jun. 17, 2024, and entitled “NETWORK INFRASTRUCTURE FOR USER-SPECIFIC GENERATIVE INTELLIGENCE”, U.S. patent application Ser. No. ______ filed Dec. 16, 2024, and entitled “MACHINE-LEARNING ALGORITHMS FOR LOW-POWER APPLICATIONS”, U.S. patent application Ser. No. ______ filed Dec. 16, 2024, and entitled “MACHINE-LEARNING ALGORITHMS FOR LOW-POWER APPLICATIONS”, and U.S. patent application Ser. No. ______ filed Dec. 16, 2024, and entitled “MACHINE-LEARNING ALGORITHMS FOR LOW-POWER APPLICATIONS”, each of which are incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNICAL FIELD

This disclosure relates generally to the field of machine learning (ML) algorithms for vision processing. More particularly, the present disclosure relates to systems, computer programs, devices, and methods that enable ML-based vision processing for low-power, embedded, and/or real-time applications.

### DESCRIPTION OF RELATED TECHNOLOGY

Machine learning (ML) techniques enable computer systems to improve their performance on a specific task through experience and data, rather than through explicit programming. Colloquially, computers “learn” from data and make predictions or decisions based on that learning.

Unfortunately, current ML techniques can consume significant amounts of power. Most current ML models are based on neural networks and transformers; these technologies exponentially scale in computational complexity based on the number of parameters (which may number in the thousands, millions, etc.). The cost of training also scales according to network size and parameter count. As a practical matter, these limitations pose substantial design constraints on low-power, embedded, and/or real-time applications.

Machine learning is particularly important for mobile devices and edge computing where power constraints are significant considerations. Thus, there is significant industrial interest in energy-efficient ML algorithms, hardware, and techniques.

### BRIEF DESCRIPTION OF THE DRAWINGS

FIG. 1 depicts an illustrative scenario useful to demonstrate the operation of a conventional object detection framework.

FIG. 2 depicts an offline training process that uses a library of training images to create sets of ML patch features, in accordance with various aspects of the present disclosure.

FIGS. 3A-3D are graphical representations of classification “stages”, in accordance with various aspects of the present disclosure.

FIG. 4 depicts a machine-learning (ML) patch feature trained for multiple resolutions, in accordance with various aspects of the present disclosure.

FIG. 5 depicts a machine-learning (ML) patch feature trained for multiple resolutions used across multiple binned resolutions, in accordance with various aspects of the present disclosure,

FIG. 6 depicts a low-power machine-learning (LP-ML) algorithm center-to-outward scan pattern, in accordance with various aspects of the present disclosure.

FIG. 7 depicts a low-power machine-learning (LP-ML) tiered scan pattern, in accordance with various aspects of the present disclosure.

FIG. 8 depicts an image that includes multiple detections (N) of a face, useful to illustrate various aspects of the present disclosure.

FIG. 9 is a logical block diagram of a user device that is configured to perform object detection, in accordance with various aspects of the present disclosure.

FIG. 10 is a graphical representation of a physical frame in accordance with various aspects of the present disclosure.

FIG. 11 is a logical block diagram of the various sensors of the sensor subsystem, in accordance with various aspects of the present disclosure.

FIG. 12 is a logical block diagram of the control and data subsystem, in accordance with various aspects of the present disclosure.

### DETAILED DESCRIPTION

In the following detailed description, reference is made to the accompanying drawings. It is to be understood that other embodiments may be utilized, and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without departing from the spirit or scope of the present disclosure. It should be noted that any discussion regarding “one embodiment”, “an embodiment”, “an exemplary embodiment”, and the like indicate that the embodiment described may include a particular feature, structure, or characteristic, and that such feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the features, structures, or characteristics of the given embodiments may be utilized in connection or combination with those of any other embodiment discussed herein.

Various operations may be described as multiple discrete actions or operations in turn, in a manner that is most helpful in understanding the claimed subject matter. However, the order of description should not be construed as to imply that these operations are necessarily order dependent. The described operations may be performed in a different order than the described embodiments. Various additional operations may be performed and/or described operations may be omitted in additional embodiments.

### 1.1 Viola-Jones Object Detection Framework and Raster Scanning

As a brief aside, “object detection”, “object recognition”, and “captioning” are three related tasks in the field of machine learning that deal with image analysis. Object detection refers to the task of identifying and localizing objects within an image or video. It involves not only recognizing the presence of objects but also identifying their size and/or locations. For example, facial detection might identify that a human face is located at a specific coordinate of an image (e.g., within a bounding box). Object recognition involves identifying and classifying objects. Unlike object detection which discriminates between different types of objects (e.g., faces from non-faces), object recognition identifies a matching object from a library of objects. For example, facial recognition identifies a likely match to a specific face from a library of face prints. Captioning, specifically image captioning, is the task of generating a textual description that accurately represents the content of an image. Image captioning models typically combine object detection and/or recognition with natural language processing techniques to generate captions that describe the scene, objects, and their relationships.

The Viola-Jones object detection framework (“VJ framework”) was an influential early object detection technique first proposed by Paul Viola and Michael Jones in their 2001 paper titled “Rapid Object Detection using a Boosted Cascade of Simple Features”, incorporated herein by reference in its entirety.

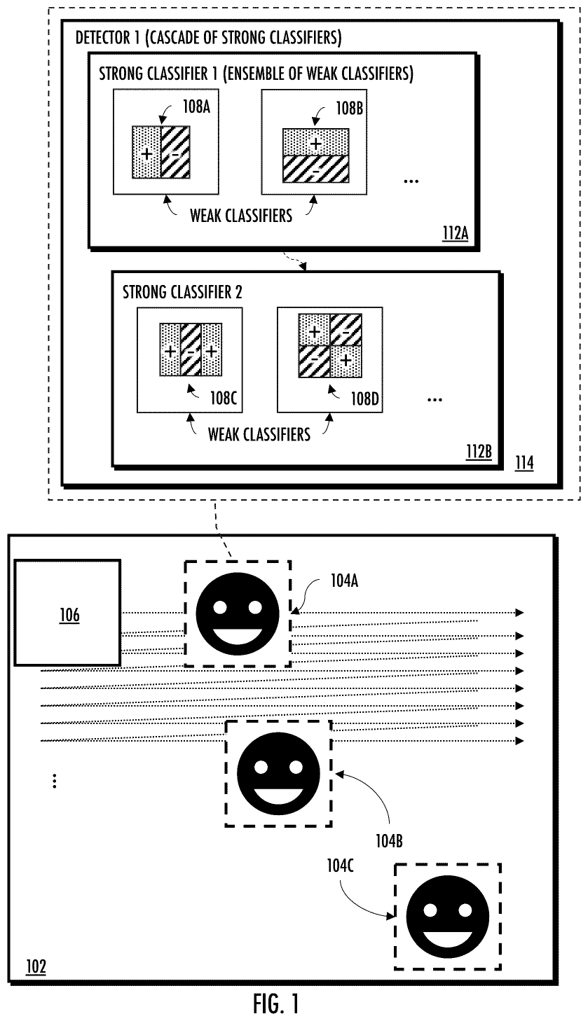

FIG. 1 depicts an illustrative scenario useful to demonstrate the operation of the original VJ framework; here, the image 102 has a frontal view of several human faces in multiple arbitrary locations (e.g., face 104A, face 104B, face 104C).

First, the image 102 is converted to grayscale (light intensity values) and used to generate an integral image. Integral images (also known as a summed-area tables or summed-area images) are data structures used to compute the sum of pixel values within rectangular regions of an image. Specifically, the integral image is constructed from the grayscale image by calculating the cumulative sum of pixel values. Each pixel in the integral image stores the sum of all the pixel values above and to the left of it in the original image. Once the integral image has been generated, the sum of any rectangular region of the original image can be calculated from the sum of the top-left value and the bottom-right value, minus the sum of the top-right value and the bottom-left value. Integral image calculations are computationally much more efficient than element-wise summation, and provide a consistent compute time for any rectangle size (2 summations and a difference).

The VJ framework used Haar-like features to identify objects within a “sub-window” 106. Notably, the illustrated example only shows four Haar-like features (108A, 108B, 108C, 108D) for ease of illustration. Haar-like features are rectangular filters that compute a single feature value by subtracting the sum of pixel values for one region (“-”) from a corresponding region (“+”). The integral image accelerates the calculation of rectangular regions; thus, this step synergistically leverages the rectangular properties of Haar-like features and integral images.

Haar-like features are based on a family of Haar wavelets, described by the following mother function (defined across the unit interval, 0≤t<1):

$$ψ ( t ) = \{ \begin{matrix}1 & 0 \leq t < \frac{1}{2} \\ - 1 & \frac{1}{2} \leq t < 1 \\ 0 & elsewhere\end{matrix}$$

Haar wavelets have many important characteristics; for example, Haar wavelets provide an orthonormal basis for a unit interval (or any scaling of the unit interval) in a single dimension. Haar wavelets are extended to two dimensions to provide a two-dimensional orthonormal basis for many image processing techniques. Much like the Fourier transform, the orthonormal properties of the family can be used to decompose any target function (such as facial features) into Haar wavelets over a target interval. Notably, orthonormality is not preserved across different rotations in two-dimensions nor across different scales for the same wavelet.

In the original VJ framework, a weak classifier was composed of a Haar-like feature. As used herein, a “weak classifier” is a classifier that performs better than random guessing. It may have an accuracy that is just above chance (e.g., slightly better than 50% for binary classification). Weak classifiers are computationally efficient; they are decision stumps (one-level decision trees), naive Bayes classifiers, or linear models with limited complexity. For example, as shown in FIG. 1, a first weak classifier might be composed of a first Haar-like feature 108A, a second weak classifier might be composed of a second Haar-like feature 108B, etc.

The original VJ framework created a “strong” classifier from an ensemble of weak classifiers. A so-called “ensemble” refers to a set of weak classifiers that are combined to compensate for their individual weaknesses, resulting in a strong classifier (e.g., strong classifier 112A, 112B, etc.) that outperforms the individual weak classifiers. Conceptually, the errors made by individual weak classifiers are uncorrelated to other weak classifiers; by aggregating their predictions, the ensemble can leverage the “diversity” of its constituent classifiers to provide a more accurate classification.

As used herein, a “strong classifier” is a classifier that provides predictive accuracy to a specific threshold (usually above 90%). As a practical matter, less than 100% accuracy means that some erroneous classifications (false positives) still occur; additionally, high accuracy rates also result in missed detections (false negatives).

The original VJ framework created a detector 114 using a “cascade of classifiers” approach. Instead of running all strong classifiers 112A, 112B on a sub-window of the image, it organized the strong classifiers into a degenerate decision tree. The set of classifiers are evaluated in a sequential (hierarchical) manner for a scan location. If the sub-window region is determined to be non-object-like, then the process was halted without processing further classifiers.

More directly, simple classifiers were used to reject the majority of sub-windows before using more complex classifiers. Importantly, each stage of classifiers was trained using examples that passed through the previous stages. Thus, subsequent classifiers had a more difficult task than their predecessors. Due to computational limitations, the original VJ framework did not seek to optimize the number of evaluated features for each stage; instead, they observed that each stage of the cascade reduced the false positive rate but also decreased detection rates (true positive rate). The original VJ framework set a target for a minimum reduction in false positives, and a maximum allowed decrease in detection rates. Each stage was trained by adding features until the target detection and false positive rates for that stage were met (e.g., a stage might have >90% target detection and <50% false positives, etc.). Stages were added until the overall target for false positive and detection rates were met (e.g., a multi-stage detector might have >99% overall target detection and <99% overall false positives with ˜10 stages, etc.).

Due to its simplicity, the original VJ framework had multiple limitations. The original VJ framework works better for faces without occlusions, frontal, upright, well-lit, full-sized, faces at fixed-resolutions (the sub-window size). When first introduced, the VJ framework gained widespread adoption due to its speed and accuracy. However, most modern computer vision applications are focused on filtering potentially interesting data out of arbitrarily complex data sets. Recently, social networks and search engines have developed facial detection engines that detect faces from arbitrarily sourced image data across the internet, etc. Such images may be captured at off-frontal views (profile or oblique angles), at different sizes, at different levels of quality, lighting, orientation, etc. The arbitrary nature of these applications poses multiple difficult challenges which far exceed the capabilities of the original VJ framework.

Most research in computer vision processing has focused on increasingly complex neural network models. For example, a convolutional neural network used by social networking applications to identify faces “in-the-wild” from social media posts might have millions of parameters. Such network sizes are often best used in large cloud infrastructure type deployments and/or heavy-duty compute solutions. In contrast, the original VJ framework used about 50K parameters to detect faces in 384×288 pixel images at 15 frames per second using a 700 MHz Intel Pentium III processor (circa 2001). Comparative levels of computational power are readily available in modern commodity processors.

As an unrelated, but important tangent, images are typically stored as a two-dimensional array of pixel values. So-called “raster scan”-based addressing orders pixel values in rows from left-to-right, top-to-bottom. Under this scheme, the uppermost leftmost pixel has a coordinate of (0, 0) and any pixel may be addressed using its row and column offset. Most image processing algorithms (including the original VJ framework) use raster scan-based addressing since it can be easily implemented in hardware and is the most widely supported image format.

In raster scan-based addressing, the actual time of detection is a function of an object's location relative to the uppermost-leftmost corner of the image. For example, the face 104A is detected before face 104B, which is also detected before face 104C. However, most detection algorithms do not report detection results until after subsequent post-processing for the whole image has completed (e.g., non-maximal suppression (NMS), etc.). In other words, the latency for the entire detection process is often a function of image size (rather than detection location).

### 2 Overview of Low-Power Machine-Learning (LP-ML) Object Detection

Recently, “smart glasses” have garnered significant consumer interest. Smart glasses attempt to incorporate computer vision processing capabilities in an eyeglass form factor; for example, many implementations of smart glasses use cameras to capture images of the external world, and a heads-up display to provide information to the user. Unfortunately, the available battery power, limited processing capability, memory size, and limited thermal dissipation capabilities are significant limitations. Existing implementations may require external battery packs, only support short usage times, and may require cooling apparatus (fans, etc.).

Most people are accustomed to special purpose eyewear (e.g., many people wear corrective lenses and/or sunglasses). Yet smart glasses have failed to provide the benefits and convenience that would allow for widespread adoption. Market research suggests that smart glasses must provide substantial utility over the course of a day in a convenient and comfortable manner. Given modern battery technologies, this limits the average power consumption of smart glasses to only a few milliwatts an hour between recharges (intermittent peak usage may be much higher). New solutions are needed to enable useful operation at these power budgets.

Eyewear has multiple salient distinctions over other personal effects; by extension, these distinctions may be leveraged by smart glasses in much more intuitive ways compared to other handheld devices and wearables. Firstly, eyewear is worn on the head in an upright position. Once donned, handling eyewear of any kind is generally undesirable (e.g., to avoid scratches and/or smudging). Additionally, eyewear is consistently worn in a physically precise location relative to the user's face e.g., eyes, ears, and mouth. Head movement is also generally much more stable and deliberate relative to other body motion, even during strenuous activity.

As an important tangent, head movement (and eye-movement, in particular) is highly indicative of attention, regardless of task or motion. Current vision research suggests that eye movement is closely tied to the human thought processes; and, by extension, human thoughts may be inferred from eye movement. For example, people often look at one another during conversations and/or other social interactions; in fact, in many cases, people will also remove face coverings since the mouth and lips are important to convey emotions, etc. As a related note, smart glasses also have access to selectively record and/or capture user activities which far exceeds e.g., other devices and entities. For example, smart glasses could autonomously capture images from the user's vantage point throughout the day; in contrast, a smart phone must be explicitly framed for shots which is much more inconvenient. In other words, smart glasses present new opportunities for facial detection and/or recognition.

One exemplary embodiment of the present disclosure performs facial detection with machine-learned (ML) patch features. ML patch features are empirically determined based on an image library. In one specific implementation, the ML patch features are determined using an offline training process and adaptive boosting (AdaBoost).

In some variants, the exemplary ML patch features are optimized for an embedded hardware environment (rather than software execution environments). For example, in one specific implementation, the patch features are composed of two (or more) distinct patches, each patch having its own patch-specific characteristics (location, size, scale, etc.). The patch features may be non-contiguous, overlap, and/or span between scales. Some patch features may compare 1×1 patches (e.g., pixel or even photosite based). While patch features may use multi-pixel patches (e.g., 1×2, 2×1, 2×2, 1×3, 2×3, 3×1, 3×2, etc.), smaller patch sizes and spacing limitations (e.g., less than W the size of the detection window) may simplify hardware implementation. Furthermore, while the foregoing discussion is presented in terms of directly captured data, the patches may specify derivatives of capture data. For example, a patch (or even a set of patches) might use sum and/or average values of multiple pixels (or photosites) instead of directly captured data.

Each patch (of a set of patches) has a distinct location, size, and/or shape. For example, a patch may be defined by its location coordinate, a width, a height, and a scale. A variety of other patch-specific characteristics may also be included/substituted with equal success e.g., type, shape, rotation, weight, average/sum, etc. Unlike, Haar-like features which are defined as a singular unit (having one e.g., location, width, height, and type); the exemplary patch features define each patch of a pair individually.

As discussed in greater detail below, ML patch features are used in combination with the image signal processor (ISP) and/or hardware acceleration to further reduce computational complexity. For example, hardware-based matrix manipulations that are commonly supported in image signal processors (ISPs) may be used to implement rotations and/or reflections. As another example, patch features with different detection window sizes can be combined with binning logic to address detection at arbitrary scales. In other words, in-camera hardware and/or capture-based information can perform image pre-processing that enables fewer less complicated ML patch features (as compared to using additional sets of patch features to handle rotations, reflections, binning, etc.).

Furthermore, smart glasses have unique insights into the user's intent. Humans naturally point their head at objects of interest; in other words, an object of interest is likely to be “centered” in the user's field of view. In some embodiments, scan patterns may leverage this natural inclination, e.g., scanning for objects may start from the center and proceed outward. More sophisticated embodiments may capture user intent with e.g., gaze point information, voice prompts, gestures, etc. to reduce the temporal and/or spatial search windows. For example, smart glasses may use the user's gaze point data to crop a region-of-interest (ROI) from the forward-facing cameras. Gaze point information may additionally be used to identify the most likely location of an object of interest.

As explored in greater detail below, cascades may provide multiple levels of “soft” information. Soft information suggests that a detection could occur nearby, thus optimized variants may additionally leverage soft information to further refine scanning patterns.

As a separate observation, objects of interest are likely to trigger multiple different detections in clusters. Non-maximal suppression (NMS) is one existing solution for handling multiple detection. Conventional NMS solutions provide one or more “bounding boxes” for each object detection. The bounding boxes for an object are grouped together; the detections with the most (maximal) number of detections are kept, the non-maximal overlapping boxes are removed (i.e., suppressed).

In one exemplary embodiment, aspects of NMS are modified to provide multiple detection integration (MDI) for high confidence detection. Specifically, multiple detectors are run in parallel and integrated according to spatially clustered detections to improve diversity, accuracy, and/or classification strength. Some variants may additionally use MDI techniques to exit the detection process early (rather than exhaustively searching through the entire image).

While the following discussion is presented in the context of facial detection, artisans of ordinary skill in the related arts will readily appreciate that the following techniques may be used with equal success in any form of detection/recognition application (e.g., text detection/recognition, object detection/recognition, etc.).

### 2.1 Machine-Learned (ML) Patch Features

Most object detection solutions (such as the original VJ framework) are designed for “best-effort” computer vision processing of images. In other words, the algorithm can use as much, or as little, time as necessary to scan through an image. Furthermore, conventional object detection solutions are optimized for a library of images that had been previously captured and developed into display formats (e.g., RGB, YCrCb, etc.). Most display formats are computationally expensive and time consuming to process. These limitations present significant challenges for real-time/near real-time/embedded applications.

As used herein, the term “online” and its linguistic derivatives refers to processes that are in-use or ready-for-use by the end user. Most online applications are subject to operational constraints (e.g., real-time or near real-time scheduling, resource utilization, etc.). In contrast, “offline” and its linguistic derivatives refers to processes that are performed outside of end use applications. For example, within the context of the present disclosure, edge inference for user applications is performed online whereas training the underlying ML patch features, etc. may be performed offline.

As used herein, the term “real-time” refers to tasks that must be performed within definitive time constraints; for example, smart glasses may capture each frame of video at a specific rate of capture. As used herein, the term “near real-time” refers to tasks that must be performed within definitive time constraints once started; for example, smart glasses may perform object detection on each frame of video at its specific rate of capture, however some variable queueing time may be allotted for buffering. As used herein, “best effort” refers to tasks that can be handled with variable bit rates and/or latency.

As used herein, the term “image” refers to any data structure that describes light and color information within a spatial geometry. As used herein, the term “exposure” refers to the raw image data that corresponds linearly to captured light (where not clipped by sensor capability) and the sensor geometry. Exposures are captured by a camera sensor (prior to demosaicing, color correction, white balance and/or any other image signal processing (ISP) image data manipulations). As used herein, the term “video” refers to any data structure that describes a sequence of image data over time. Typically, video data is formatted as image frames which are displayed at a frame rate.

The term “linear” and “linearity” refer to data that preserves the arithmetic properties of addition and scalability across a range. For example, when incident light on a photosite is doubled, the number of photoelectrons doubles, and their corresponding luminance values double. In contrast, “non-linear” refers to data that disproportionately scales across a range; images that have been developed from exposures (demosaiced, color corrected, white balanced, etc.) are non-linear and cannot be linearly summed.

“Sensor geometry” refers to the layout of the camera sensor itself. While image pixels are generally assumed to be “square” and of uniform distribution, camera sensors must fit wiring, circuitry, color filters, etc. within the camera sensor. As a practical matter, the physical photosites may have device-specific geometries (square, rectangular, hexagonal, octagonal, etc.) and/or non-uniform positioning. These factors are later corrected by the image signal processor (ISP), when converting the raw exposure data to images.

Aspects of the present disclosure revisit and modify concepts from the original VJ framework for the unique considerations of real-time/near real-time/embedded applications. In one exemplary embodiment, smart glasses use classifiers that are based on machine-learned (ML) patch relationships. The ML patch features are determined during an offline training process. While the following discussion is presented in the context of smart glasses, the techniques may be broadly applicable to any embedded object detection application. Common examples of such applications include robotics, automation, self-driving cars, drones, and a variety of consumer electronics (e.g., smart phones, computers, cameras, smart watches, smart appliances, etc.).

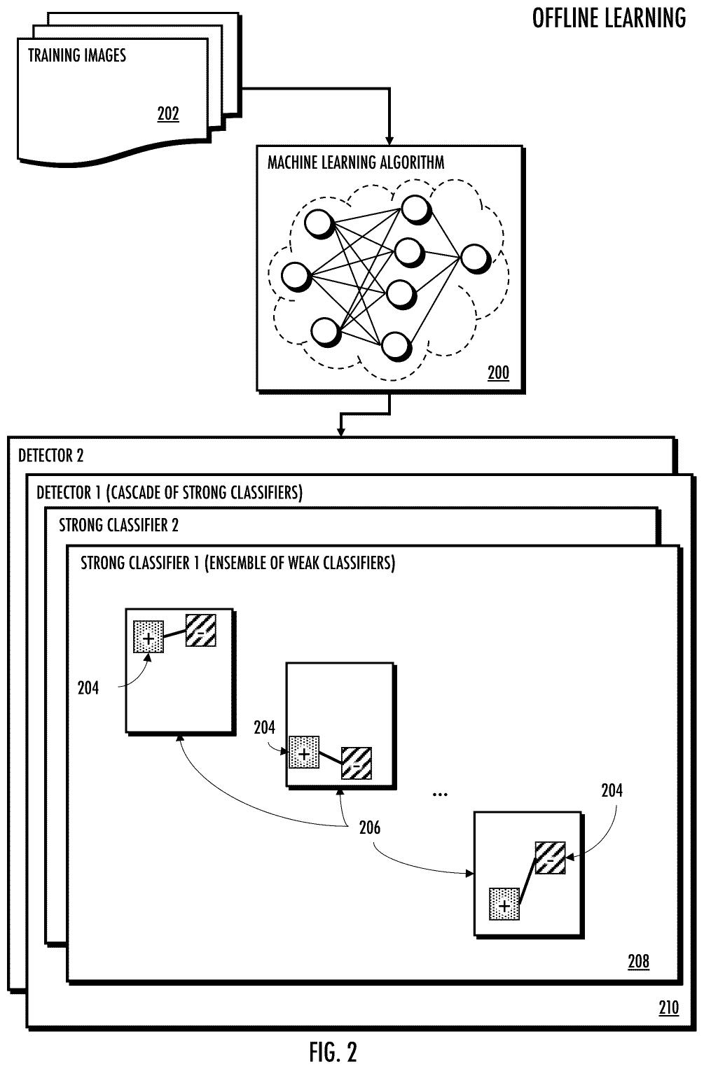

As shown in FIG. 2, an offline training process (a machine learning algorithm 200 such as Adaboost) uses a library of training images 202 to create sets of ML patch features 204. The ML patch features 204 are used to create weak classifiers 206. The weak classifiers 206 are then grouped into ensembles for strong classifiers 208. Strong classifiers 208 may be implemented as a cascade of classifiers. Multiple strong classifiers 208 are grouped into detectors 210. Multiple detectors 210 may be used sequentially, or in-parallel execution.

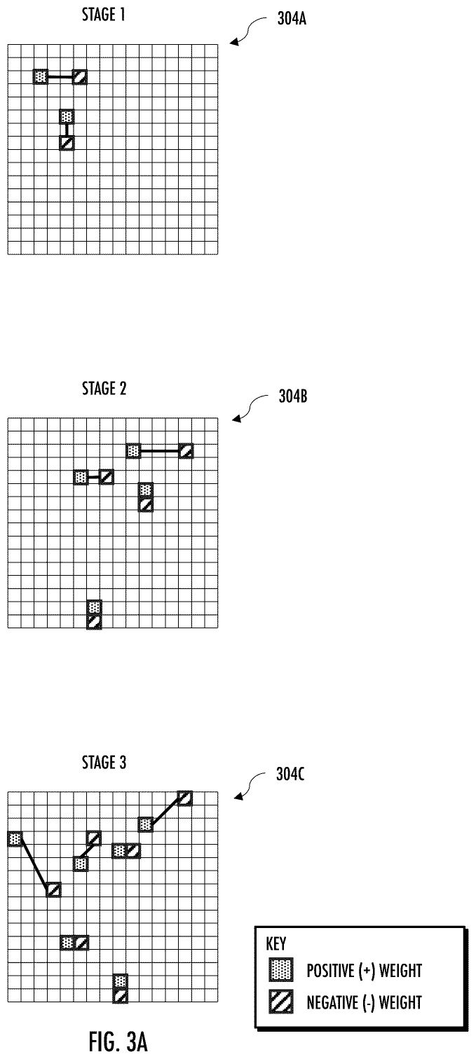

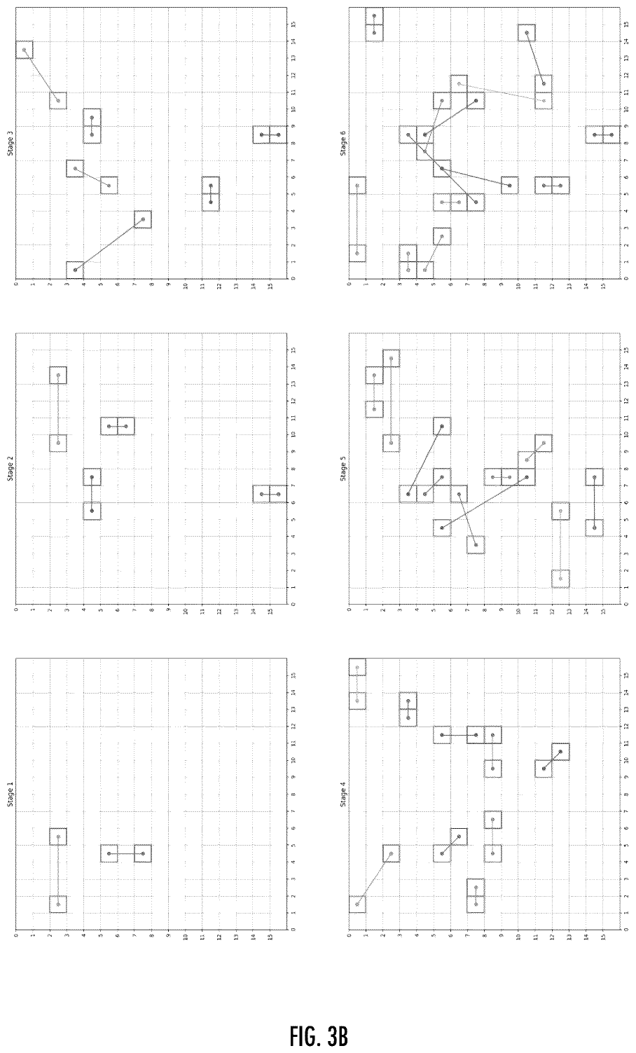

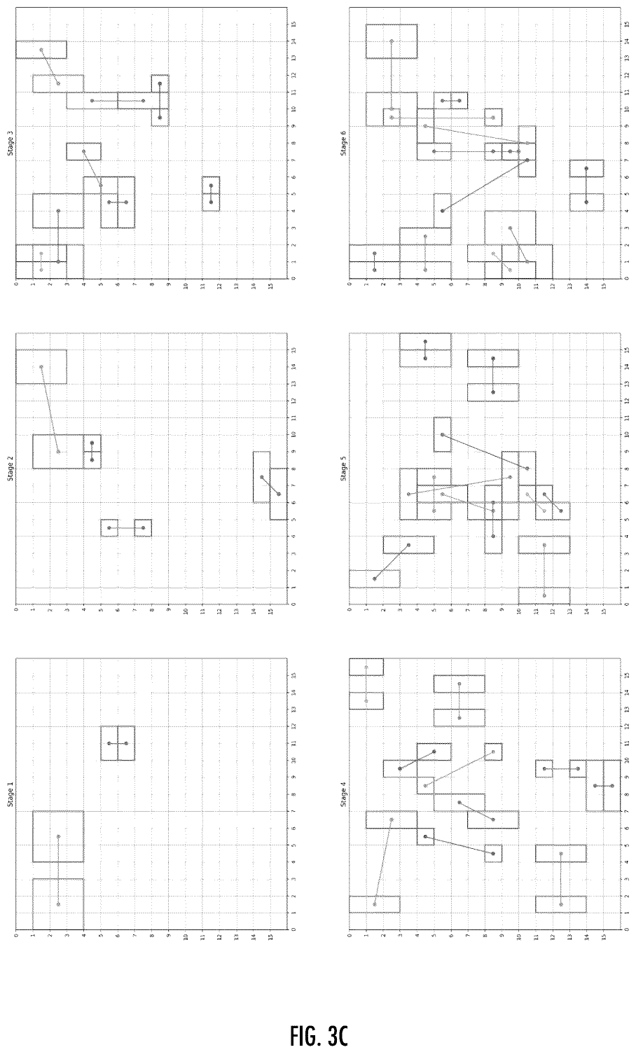

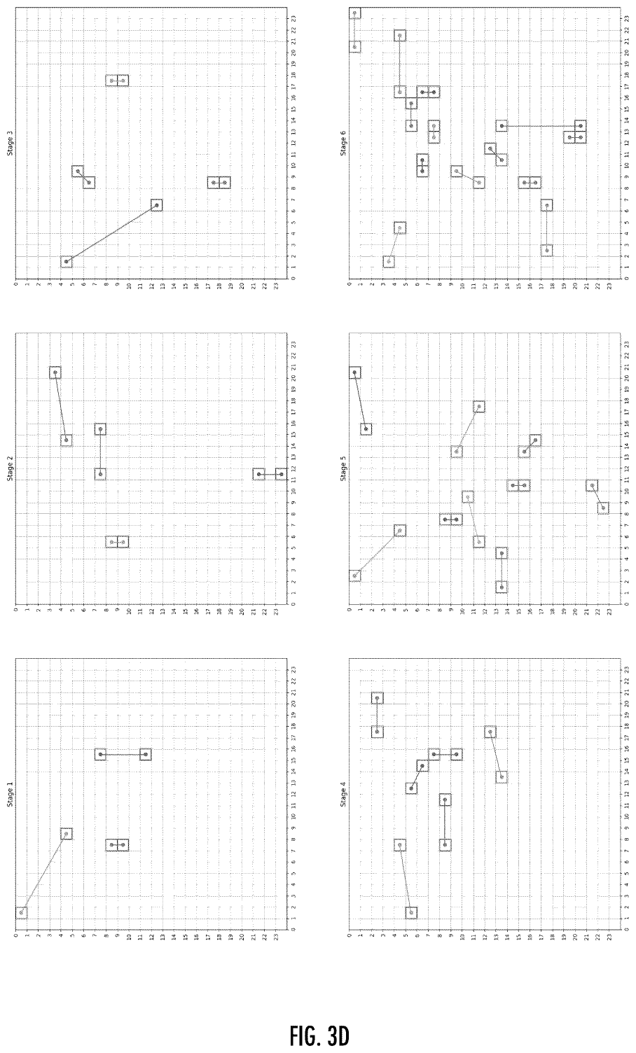

Focusing first on the ML patch features, consider the illustrative implementation depicted within FIG. 3A. Here, the strong classifiers use varying numbers of equal-sized “patches” e.g., first strong classifier 304A uses 2 weak classifiers, second strong classifier 304B uses 4 weak classifiers, third strong classifier 304C uses 6 weak classifiers, etc.). During operation, each ML patch feature adds a set of positively weighted light information and a set of negatively weighted light information.

As used herein, the term “patch” and its linguistic derivatives refer to a geometric subset of a larger body of light information (e.g., image or exposure). Patch geometry may be based on photosite (in-camera sensor) or pixel (post-capture processing) shapes. While the illustrated patches are square, camera sensor-based patches may correspond to the device-specific geometries (square, rectangular, hexagonal, octagonal, mixed polygon, etc.) and/or non-uniform positioning of the camera sensor itself.

FIGS. 3B-3D are additional examples of classification “stages”. Each stage is a strong classifier which includes multiple features. FIG. 3D provides examples of 24×24 strong classifiers based on the ML patch features (which are dissimilar from the 16×16 ML patch features of FIGS. 3A-3C). Different sub-window sizes may require additional offline training to derive the ML patch features of the strong classifiers. In other words, a first offline training may be used to generate the 24×24 ML patch features, a second offline training may be used to generate the 19×19 ML patch features, and a third offline training may be used to generate the 16×16 ML patch features. In some cases, each offline training process may additionally require a different fixed dataset (e.g., a 24×24 data set, a 19×19 data set, a 16×16 data set, etc.). As previously noted, offline training complexity may be performed by cloud compute resources at best-effort; the resulting set of ML patch features can be stored at the user device for real-time or near real-time edge inference.

As previously noted, Haar wavelets are characterized by a specific mother function that defines one and only one value for each point in the range. Haar-like features re-use the formulation of the Haar wavelet to leverage the computational efficiency of integral image calculations. As a result, Haar-like features are defined as singular units; they describe rectangular features that are always adjacent to one another (contiguous), edge aligned, of the same scale, and anchored at the uppermost-leftmost corner coordinate. In contrast, ML patch features may be in any arbitrary geometry and/or orientation and may be anchored at the center coordinate. The flexible nature of patch-based features means that a much greater number of permutations are possible-since, in a given space, there are many more possible patch features than Haar-like features. As discussed elsewhere, the myriad of possible patch features are filtered using ML training techniques to yield ML patch features.

Importantly, ML patch features may be of any geometry. Rectangular ML patch features may be used with integral image data, since integral image calculations are more computationally efficient for direct summations. However, pre-ISP sensor data may not be rectangular; thus, non-rectangular variants may enable ML patch feature classification earlier in the image processing pipeline. This may be useful for adjusting latency to e.g., improve real-time and/or near real-time scheduling. Other variants may use early ML patch feature classification to enable detection under low power/sleep modes (e.g., when one or more of the ISP, DSP, GPU, etc. are powered down, etc.).

ML patch features may have arbitrary positioning, e.g., they may be overlapping, non-adjacent, and/or non-edge aligned. In fact, ML patch features may even compare patches between images of the same or different scale. For example, a patch from a 16×16 sub-window may be compared to an average of four patches from a 32×32 sub-window, etc. Overlapping features may be used in the same, or different scales. For example, two 1×2 patches might overlap within the same scale; similarly, the average of a 9×9 patch at a first scale might be compared to an overlapping 1xi patch at a second scale (e.g., a “doughnut” overlap).

ML patch features may be anchored at a center coordinate. In other words, the location of each patch (of the set of patches) is described relative to a center coordinate (rather than a corner coordinate, as is done for Haar-like features). More directly, row/column addressing may extend in both positive and negative directions relative to the center coordinate (e.g., corner anchored addressing mechanisms often assume only positive row/column offsets and/or fixed dimensions). These aspects of center anchored addressing enable a variety of computational efficiencies and/or capabilities. For example, certain types of vector and/or matrix operations (e.g., rotations, mirroring, and scaling) can be performed without translation pre-processing.

Additionally, while corner anchored addressing often assumes positive (unsigned) offsets and fixed dimensions, center anchored addressing uses signed offsets and without dimension assumptions. For example, artisans will readily appreciate that the sub-window is only a portion of a larger image data set. Thus, center anchored addressing can use positive and negative offsets to describe patches outside a bounding box. In other words, some variants may compare patches against image information from outside the sub-window. This may be important for e.g., scaling pixels near the edge of the sub-window. Other applications may include e.g., differentiating object features from non-object features. For example, consider a person wearing a hat. The hat may be used in ML patch features to compensate for unusual shadows on the face. However, the resulting bounding box may be focused on the person's face (excluding the hat).

Empirical evidence shows that the ML patch features can provide comparable or better performance, speed, and power efficiency to Haar-like features for facial detection, by using a greater number (approximately 27% more) of simpler features (e.g., 1×1, 1×2, 2×1, 2×2, 1×3, 2×3, 3×1, 3×2, etc.) potentially across multiple stages (3 or more stages). More generally, these results suggests that ML patch features may be broadly extended to other classes of object detection with varying degrees of numbers and/or stages. Artisans of ordinary skill in the related arts will readily appreciate that these parameters may be extended to achieve a broad spectrum of performance, speed, and/or power efficiency. For example, increasing/decreasing the number and/or size of the features may be used to trade-off between performance and power. Increasing or decreasing the number of stages may also be used to trade-off between power savings and speed.

Furthermore, non-adjacent/non-edge aligned patch relationships have additional properties that are desirable. In particular, the ability to change the location of one patch relative to another may be used to modify the ML patch classifier (during online operation) for rotations, translations, scaling, mirroring, etc. For example, rotation may be difficult with Haar-like features. In conventional object detection solutions, the images are rotated so that the Haar-like feature may be used in its normal orientation (which is important for integral image calculations) or the model must actually be trained for different rotations, etc. In contrast, a rotation of ML patch features can be approximated by changing the coordinates of the patches relative to one another. Similar effects may be observed with translations, scaling, mirroring/flipping, etc. In other words, handling image modifications by changing the ML patch feature coordinates may be much more efficient than trying to modify the image data or run a more complicated model.

As a brief aside, a feature may be transformed by applying the following transformation matrix (M) to the coordinate vector (x, y), according to EQN. 1:

$$[ \begin{matrix}{x}^{′} \\ {y}^{′}\end{matrix} ] = [ \begin{matrix}cos θ & - sin θ \\ sin θ & cos θ\end{matrix} ] [ \begin{matrix}x \\ y\end{matrix} ] \qquad EQN . 1$$

where θ is an angle of rotation.

In left-handed cartesian coordinate systems, the matrix rotates clockwise through an angle θ about the origin. As demonstrated in EQN. 1, center anchored addressing schemes can be manipulated “as-is” using vector matrix operations (corner anchored addressing requires translation prior to, and after, the transformation). Direct transformations without translation may be extended to other operations as well (e.g., mirroring, flipping, scaling, etc.).

Artisans of ordinary skill in the related arts will readily appreciate that the transformation matrix may be normalized (unity gain) or non-normalized. In some cases, non-normalized matrices may be preferred to minimize bit precision requirements. Certain transformations may be calculated in advance; some examples are provided below.

EQN. 2 is a 45-degree rotation (non-normalized to reduce bit precision requirements):

$$M = [ \begin{matrix}1 & - 1 \\ 1 & 1\end{matrix} ] \qquad EQN . 2$$

EQN. 3 is a go-degree rotation:

$$M = [ \begin{matrix}0 & - 1 \\ 1 & 0\end{matrix} ] \qquad EQN . 3$$

EQN. 4 is a left-flipped rotation (horizontally mirrored across the y-axis).

$$M = [ \begin{matrix}- 1 & 0 \\ 0 & 1\end{matrix} ] \qquad EQN . 4$$

EQN. 5 is a 180-degree rotation (vertically mirrored across the x-axis).

$$M = [ \begin{matrix}- 1 & 0 \\ 0 & - 1\end{matrix} ] \qquad EQN . 5$$

EQN. 6 illustrates asymmetric scaling 1.5 in the x-dimension 1.2 in the y-dimension (symmetric scaling may also be implemented with equal success).

$$M = [ \begin{matrix}1.5 & 0 \\ 0 & 1.2\end{matrix} ] \qquad EQN . 6$$

Feature transformation may be accomplished by multiplying the transformation matrix to coordinates of the patch features (e.g., rectangles). The transformed feature may be effectively scaled and translated about its center coordinate without substantially changing the geometries of the rectangles (size and shape). In some implementations, the rotations may be selected to minimize bit precision requirements. For example, the simplicity of the matrix operations might be implemented with as few as 4 bits (e.g., 2 bits for integer precision and 2 bits for fractional precision).

In some variants, higher bit precision may be used to increase multiplication and/or division granularity. This may enable e.g., fractional scaling ratios. Fractional scaling may be used to smooth transitions between detection windows, binning resolutions, etc. (as discussed in greater detail below). As but one such example, instead of training many different window sizes (e.g., 16×16 19×19, 24×24, etc.), a few windows may be scaled with transformation matrices (e.g., 16×16 with a 1:1, 1.2:1.2, 1.5:1.5 scaling ratio) to provide similar performance. Scaling may be symmetric or asymmetric—e.g., a 16×16 window scaled by 1:1.2 emulates a 16×19 window. Asymmetric scaling may be used to compensate for non-square aspect ratios. For example, a non-square sensor may have a different number of rows and columns. Here, row/column stride sizes and/or horizontal/vertical dimensions may be asymmetric to amplify or attenuate these effects.

Other neural network technologies may also benefit from the ML patch features described throughout; for example, the receptive field of convolutional neural networks (CNNs) is a function of the number of layers of the network and the size of the filter. A 3×3 filter can only “see”+/−1 pixel away in a single layer; CNNs for images and/or videos usually have many layers to extend this range. This is largely due to the “sliding” behavior of convolutions (e.g., one element at a time). The flexibility of non-adjacent patch relationships could be used to greatly reduce the number of layers needed for a CNN.

As a brief aside, transformations may enable efficient re-use of ML patch features. Consider a person wearing smart glasses that tilts their head; their head tilt will induce a counter tilt in the captured images. The counter tilted image may exceed the nominal range of the ML patch features. In one specific implementation, the ML patch features may use sensed input to select a counter rotation transformation in real-time. Notably, rotating the ML patch features may be preferred over training a model for larger rotational angles (training is computationally difficult) and/or rotating the search space (rotating the image requires a rotation of every pixel). While, the performance of modified ML patch features may decrease, these modifications are significantly easier than transforming image data in terms of both processing cycles and memory footprint. In fact, transformations may even be handled in dedicated hardware (e.g., matrix transformations are often accelerated within ISPs/DSPs, etc.). More generally, the tradeoff in performance for efficiency may be preferred for a variety of resource considerations (power, processor cycles, bandwidth, and memory space). Mirroring may have similar applications (e.g., a right hand detection may be emulated with a mirror of the left hand, etc.).

There are many possible combinations of patch relationships. For example, there are over 130,000 possible 1×1 patch combinations in a 16×16 image (e.g. 2×256×255 potential patch locations). Larger patch combinations would further increase the total number of possible combinations, which far exceeds the number of Haar-like features for the same image size. As a practical matter, identifying patch comparisons is a significant undertaking. Exemplary implementations use offline training to generate ML patch features for the user device. In other words, critical patches for ML patch features can be identified using cloud compute resources at best-effort. The resulting set of ML patch features can be stored at the user device for real-time or near real-time object detection. Other implementations may use online training techniques where e.g., flexibility is prioritized over performance and/or power.

Referring back to FIG. 2, exemplary embodiments of the present disclosure create multiple detectors. Real-world applications span a wide variety of different conditions, whereas detectors are often trained with libraries of images taken under specific conditions. Different detectors may be combined in various degrees to achieve varying degrees of accuracy and robustness across different environments (e.g., well-lit, poorly-lit, subject motion, device motion, etc.). For example, multiple detectors may be used at different scales and/or run in parallel. Other implementations might generate multiple results and combine them to arrive at a hybrid false positive/detection rate of the two. Other techniques may combine detectors according to e.g., statistical analysis (e.g., Bayesian probability), historic performance, user selection, etc.

As used herein, the term “classification strength” and its linguistic derivatives quantify and/or characterize positive and/or negative classifications relative to false positives and false negatives.

As previously noted, different detectors may be run in sequence or in parallel. For embedded applications, power consumption is often directly related to computational load, thus, certain variants may selectively enable or disable detectors. This may be particularly useful in applications where the usage scenario can be used to limit or otherwise constrain the scope of detection.

As discussed throughout, the detection process may terminate after a single detection (early termination), the techniques may be broadly extended to multiple detection processes (or threads). Such scenarios may arise where a target region-of-interest could include two or three faces; in some cases, these scenarios might be pre-emptively detected based on e.g., multiple voice detections, previous history, user configuration, etc. In such variants, multiple detection processes may proceed concurrent with each other. In some cases, detection processes may notify the other detection processes of a keep-out region; this may prevent unnecessary searches and/or duplicative search results.

### 2.1.1 Optimized Variant: Binning and Variable Detection Window Size

Perspective is a visual effect that occurs when objects or elements in an image appear to change in size and position as they move closer to or farther away from the viewer's point of view. This effect is a result of the way three-dimensional scenes are captured onto a two-dimensional surface, such as a camera sensor. As previously noted, the original VJ framework was optimized to detect faces at fixed-resolutions (corresponding to the sub-window size). However, real-world facial detection applications need to identify faces at a variety of distances (resulting in a variety of sizes).

Various embodiments of the present disclosure may incorporate “binning” or “skipping” camera sensor reads. As a brief aside, certain terms within the sensor arts are often confused with similar terms in the computing arts. For example, a “read” might ambiguously refer to discharging the stored potential within a photosite or the resulting digital value read from the ADC. Within the context of the present disclosure, a “photosite discharge”, “discharge”, and their linguistic derivatives explicitly refer to the act of discharging the electrical potential stored within a photosite. Unlike digital data that may be stored, written, and read any number of times, a photosite discharge is a “destructive” analog process i.e., the discharge can only occur once for an exposure.

During a binned read, multiple photosites are discharged and their corresponding digital values are summed together. For example, binning logic might discharge four (4) photosites (2 rows by 2 columns, “2×2”) to create a single digital value. Artisans of ordinary skill in the related arts will readily appreciate that a variety of other binning techniques may be used with equal success. Some implementations combine the analog electrical potential (prior to ADCs), others sum digital values (after ADCs). Still other implementations may combine-and-sum (e.g., combining electrical potential for two pairs of photosites, and summing the resulting digital values, etc.). Regardless of the specific implementation details, binning technologies enable cameras to capture high resolution images in full-light, while also emulating a much larger photosite (with less granularity) using the same sensor in low light. “Skipping” reads are a related technology. During a skipping read, only a subset of the image is read (e.g., every other photosite, etc.). In effect, this technique may be used to cut the image size in half, quarter, eighth, sixteenth, etc. Notably, the read values directly correspond to the photosite discharge value; i.e., skipping reads do not average multiple photosites together.

Camera sensor-based scaling techniques (such as binning and skipping) are power efficient since they generally reduce the amount of data that must be transferred from the camera sensor. However, since discharges are destructive, these techniques may not be able to recover original capture data. In other words, original photosite values often cannot be recovered from binned image data. Some implementations may implement sampling/scaling on the full set of image data with arithmetic operations (e.g., at a processor); while this preserves the original image data, it consumes more power during transfer and uses more memory for storage.

As a brief aside, “sampling” and “scaling” are two different concepts, although they are related. Downsampling reduces the resolution or quality of image data by reducing the number of samples, data points, or bits used to represent the data; upsampling attempts to increase the resolution or quality of image data by increasing the number of samples, data points, bits, etc. Scaling rescales image data to a different resolution. Sampling may be considered a subset of scaling; scaling techniques may additionally incorporate e.g., interpolation, averaging, summing, filtering, and/or other techniques that synthesize image data from sampled image data.

More detailed discussions of scalable processing techniques are discussed within U.S. patent application Ser. No. 18/316,181 filed May 11, 2023, and entitled “METHODS AND APPARATUS FOR SCALABLE PROCESSING”, U.S. patent application Ser. No. 18/316,214 filed May 11, 2023, and entitled “METHODS AND APPARATUS FOR SCALABLE PROCESSING”, and U.S. patent application Ser. No. 18/316,206 filed May 11, 2023, and entitled “METHODS AND APPARATUS FOR SCALABLE PROCESSING”, each of which are incorporated herein by reference in its entirety.

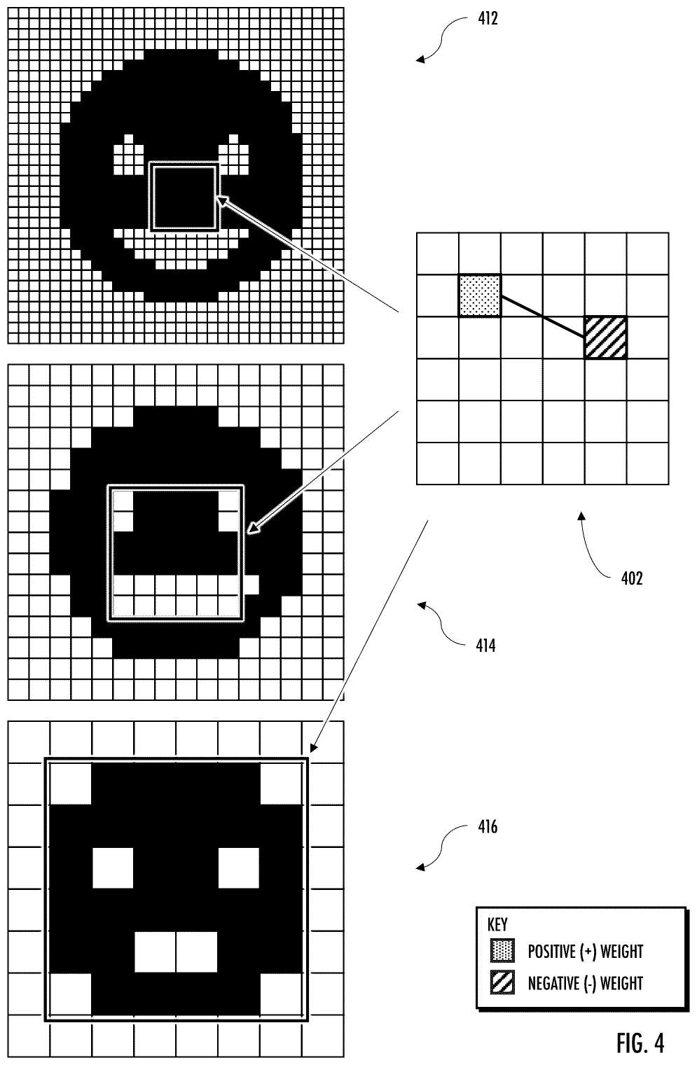

Consider the illustrative scenario depicted within FIG. 4; as shown, a ML patch feature 402 trained for a sub-window resolution of 6×6 is shown relative to a first image 412 of a face (32×32), a second image 414 of a face (binned to 16×16), and a third image 416 of a face (binned to 8×8). Here, the binned image may be obtained from the camera sensor, or may be separately binned at the processor.

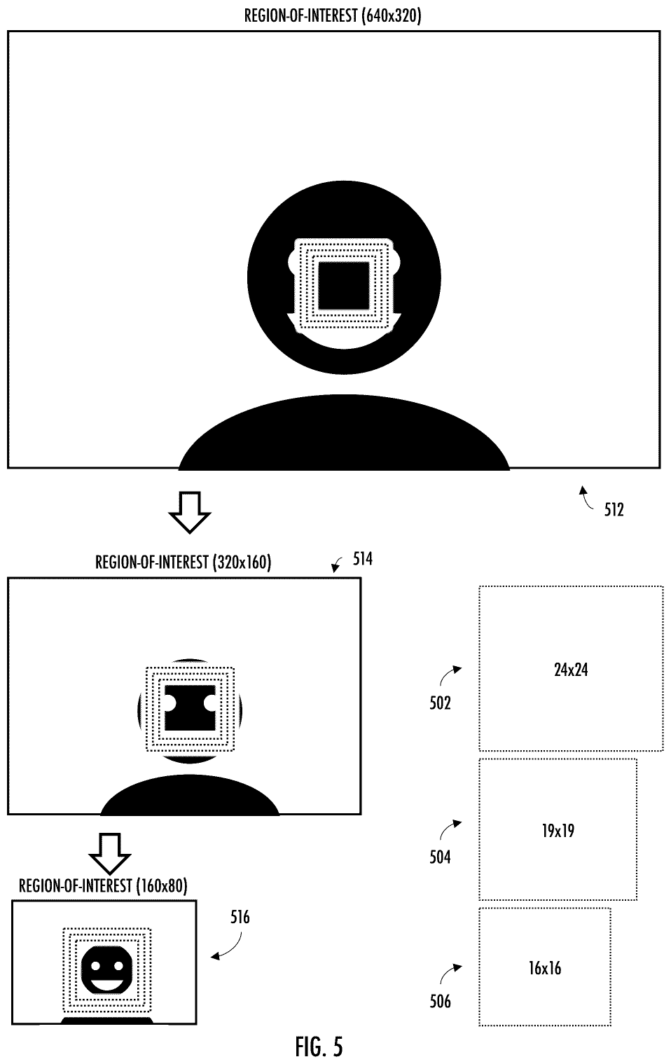

Binning and its related variants can be used to handle large variances in object size with modest computational effort. However, there may be significant gaps between detections. In other words, some applications may require more granular detection between binned resolutions. To these ends, exemplary embodiments of the present disclosure may additionally incorporate multiple different ML patch feature sizes. As shown in FIG. 5, a first set of ML patch features 502 of a first size (24×24), a second set of ML patch features 504 of a second size (19×19), and a third set of ML patch features 506 of a third size (16×16) may be used at multiple binned resolutions (e.g., a full resolution 512, quarter resolution 514, sixteenth resolution 516, etc.).

In the illustrated example, the ML patch feature window size scale factor (1×, 1.2×, 1.5×) in combination with the binning resolution (full, quarter, sixteenth) may allow for much more granular object detections at each scale. This relationship may be characterized according to the ratio of the classifier window size to the total search area, such as is summarized in Table 1.

TABLE 1

| | 16 × 16 | 19 × 19 | 24 × 24 |
|---|---|---|---|
| | (1X scale) | (1.2X scale) | (1.5X scale) |
| 640 × 320 (204800px) | 0.13% | 0.18% | 0.28% |
| 320 × 160 (51200px) | 0.50% | 0.71% | 1.13% |
| 160 × 80 (12800px) | 2.00% | 2.82% | 4.50% |

### 2.2 Center-to-Outward Scanning and Soft Information Refinement

As previously noted, head movement (and eye-movement, in particular) is highly indicative of attention, regardless of task or motion. Thus, various aspects of the present disclosure leverage user intent information inferred from eye-tracking information. In one exemplary embodiment, the smart glasses use a scan pattern that starts at a likely point of interest for the user. This might be the center of the image (which roughly corresponds to the user's head direction) and/or the gaze point in the image (which may be inferred from eye-tracking data). Scans radiate outward (e.g., spiral, star, random, ML-driven, etc.) until one or more objects are found. In other words, the scan is performed so that objects that are likely to be of interest to the user are detected first. In some variants, successful detection may end the detection process (only one face is detected). In other variants, location(s) of multiple detections may be provided to a co-processor for further processing concurrent with continued search (multiple faces are detected, but the centermost faces are detected first).

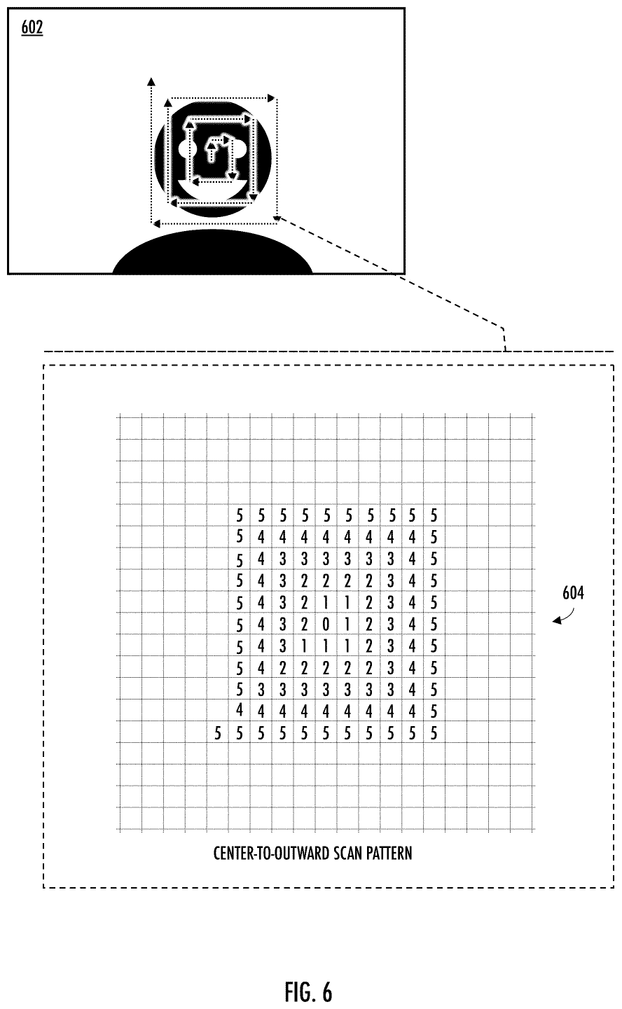

Referring now to FIG. 6, a low-power machine-learning (LP-ML) algorithm performs facial detection on the image 602. Specifically, the LP-ML logic scans the image 602. However, instead of performing a raster scan (left-right, top-bottom), the scan starts at the center of the target region-of-interest and proceeds outward according to a scan pattern 604. While the scan is shown from the “center”, the concepts described herein may be broadly applicable to any point corresponding to likely user interest; for example, the scan could begin at the gaze point or some offset from the gaze point (e.g., parallax offset, etc.). Other implementations might consider image information (e.g., shapes, color, movement, etc.) which might attract user interest, etc. For example, “flesh-toned” colors or certain shapes/movements that might be associated with facial features might be used to identify a starting point.

In the illustrated embodiment, the scan pattern 604 proceeds “outward” according to a clockwise (or counter-clockwise) spiral. More generally, however, any scan pattern that traverses from locations of high likelihood to lower likelihood of user interest may be substituted with equal success. Scan patterns may be e.g., spiral, star/spoke, random, ML-driven, randomized, based on eye-tracking information, previous history, etc.

In one embodiment, the scan pattern is a pre-defined set of strides having direction and distance, starting from an initial coordinate. Pre-defined data structures can be stored in advance, and retrieved in real-time. For example, a spiral pattern characterized by up, left, down, down, down, right, right, right, etc., might be described by the array of relative coordinates (0, +1), (+1, 0), (0, −1), (0, −1), (0, −1), (−1, 0), (−1, 0), (−1, 0), etc. These stride lengths may be further adjusted in magnitude (e.g., (0, +3) would be a stride length of 3 elements in the y-direction). The stride data structure may even incorporate diagonal strides (e.g., (+2, +3) indicates a stride of 2 in the x-direction and 3 in the y-direction). Other variants may calculate stride direction and distance to e.g., provide more flexibility, etc. For example, a “radial” motion may be calculated and rounded to the nearest element, etc. Various other methods for defining a scan pattern may be substituted with equal success.

Certain implementations might consider image information (e.g., shapes, color, movement, etc.) in determining scan pattern. For example, eye-tracking history might be used to prioritize scan area, e.g., vertical eye-tracking history might correspond to larger vertical spans in the scan pattern, horizontal eye-tracking history might correspond to larger horizontal spans in the scan pattern, etc. As another example, large horizontal swathes of blue (usually indicative of a sky) might be used to prioritize wider horizontal scan area, etc.

As a brief aside, the human gaze generally moves in rapid, jerky movements (“saccades”) as they change focus from one point to another. Notably, saccadic movements are typically not “spiral” in nature. Thus, certain implementations may identify a scan pattern that is more human-like. Here, eye-tracking data may be taken from a general population and/or from the user's own patterns. In some cases, the eye-tracking data may be compared against the subject images to determine how different image data affects the saccadic movements. For example, the human eyes may move differently when scanning a face, compared to text, or other objects. These saccadic movements may then be used as the basis for type-specific scan patterns, e.g., saccadic movements for faces (triangular patterns roughly corresponding to e.g., eyes, nose, mouth, etc.) are used for facial detection, saccadic movements for text (F-patterns which roughly correspond to scanning for topic sentences, etc.) are used for text detection, etc.

While center-to-outward scan patterns may be used in combination with ML patch features, they are a wholly separate aspect and may be broadly extended to any object detection framework. For example, center-to-outward scan patterns might be used in conjunction with Haar-like features for an improved implementation of the VJ object detection framework. Still other neural network-based object detections might be used in combination with center-to-outward scan patterns.

Furthermore, while the scan pattern of FIG. 6 is depicted at pixel granularity, other implementations may skip one or more pixels to cover the search area more quickly. In fact, exemplary embodiments may use “soft” information to further refine the scan locations.

Within the context of information theory and data processing, the term “hard” and its linguistic derivatives refers to information that is treated as certain or deterministic (representable as a binary “1” (true) or “0” (false)). In contrast, “soft” and its linguistic derivatives refers to information that has some uncertainty, probability, or likelihood. The sum of likelihoods for non-detection and detection is assumed to be 100%; in other words, a soft non-detection is also a soft detection and vice versa. Soft information is used to concisely refer to this interchangeable relationship.

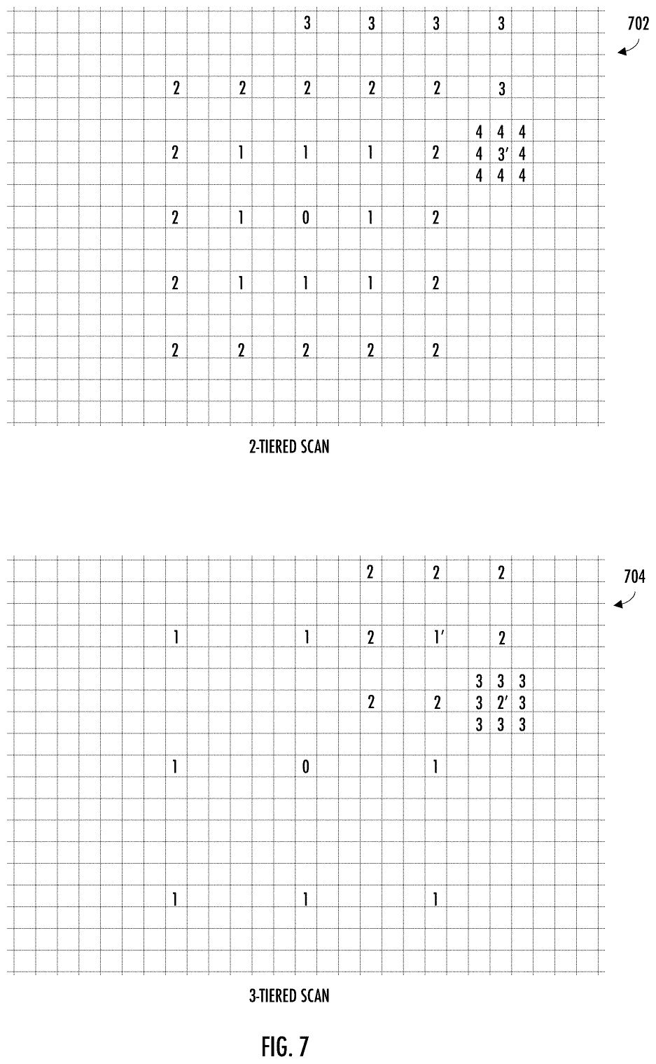

Consider the examples of FIG. 7, where a multi-stage detector uses tiers of classifiers to infer soft information. In one exemplary 2-tiered scan scenario 702, a 2-tier cascade of classifiers is used to infer soft information. Each tier corresponds to a number of stages that achieves a desired target detection (tier target detection) and a desired false positive rejection rate (tier rejection rate). Thus, a 2-tiered scan scenario might break a 10-stage detector into the first 5 stages (1-5) and the second 5 stages (6-10). Specifically, no matches (no detection at the first tier) corresponds to a hard non-detection, a first tier match provides some soft information, and a successful completion (both tiers succeed) corresponds to a hard detection. When a hard non-detection is found, the detector moves to the next scan location in the scan pattern. When soft information is found, the detector refines its search vicinity until a hard detection (or hard non-detection) is conclusively determined.

As used herein, the term “vicinity” refers to a search area, stride size, true distance, Manhattan distance, path distance, or other parameter from a specific point of reference. In some implementations, an ML patch feature may be associated with a specific area constraint; in other words, a match identifies a search area for the next stage (e.g., 3×3 pixel area, 5×5 pixel area, 9×9 pixel area). Some variants may use a distance constraint e.g., a substantially circular patch of pixels, etc. Still other implementations may identify a specific scale constraint e.g., the current scale, one or more scales above/below, etc. Constraining subsequent searches to a vicinity prevents unbounded searches (e.g., where the previous stage had a false positive classification).

Here, a “stride” refers to a number of elements that are skipped when traversing to the next element. Stride length may refer to the number of elements, and a stride direction may refer to the direction of the traverse (e.g., horizontal and/or vertical, and/or some ratio of horizontal and vertical, etc.). In some variants, stride may additionally be characterized as positive or negative. For example, a scan pattern that spirals clockwise (or counter-clockwise) from center-to-outward may have positive strides when increasing the x-coordinate or y-coordinate, and negative strides when decreasing the x-coordinate or y-coordinate, etc.

As shown in the exemplary 2-tiered scan scenario 702, a center-to-outward scan starts at scan location 0 (non-detection) and proceeds to other scan locations according to a coarse granularity based on hard non-detections. For example, as shown, the scan pattern radiates outward at a coarse granularity as indicated by scan locations 1, 2, etc. The coarse granularity search has a row and column stride size of 3 along the scan pattern. When a soft information is detected (at scan location 3′, the first tier succeeds and the second tier fails), the coarse search pattern is refined to a fine granularity search (scan locations 4). Here, the fine granularity search has a row and column stride size of 1 along the scan pattern. The finer granularity search may perform a complete 2-tier search (performing both first tier and second tier) or may pick-up where the last detection failed (e.g., performing only the second tier). Each tier may be implemented with stages, or a subset of stages, within the detector. In some cases, different detectors may also be used where the last detection failed, etc.

In some cases, the scan pattern may be associated with a tier. A first tier of pixels may be further associated with its second tier of pixels in a hierarchical manner (e.g., the first tier is a parent pixel of the next tier, etc.). In other words, child tier locations are only scanned if its parent pixel had some level of soft information detection. Parent/child relationships may be spiral, circular, spoke, star, etc.

As another example, in exemplary 3-tiered scan scenario 704, a 3-tier cascade of classifiers is used to infer soft information. Here, the 3-tiered scan scenario might break a 10-stage detector into the first 5 stages (1-5) and the second 3 stages (6-8) and the last 2 stages (9-10). No matches correspond to a hard non-detection, the first tier corresponds to a first degree of soft information (more likely to be a non-detection), the second tier corresponds to a second degree of soft information (more likely to be a detection), and the third tier results in a hard detection.

In this example, a center-to-outward scan starts at scan location 0 (non-detection), and proceeds to other scan locations (scan locations 1) according to a coarsest granularity. Once a first degree of soft information is detected (scan location 1′), the coarsest search is refined to a moderate search (scan locations 2). When a second degree of soft information is detected (scan location 2′), the moderate search is refined to a fine search (scan locations 3). As before, each refinement may perform complete scans at the finer resolution (level 0, level 1, level 2), or may pick-up where the previous scan left off (e.g., scan locations 2 start with level 1 scanning, scan locations 3 start with level 2 scanning, etc.).

Different search granularities may be associated with different classification characteristics for each stage of the cascade. For example, coarser stages may focus on robust detection (e.g., false positives are more acceptable than missed detections). In contrast, finer stages may focus on accuracy (false positive/negative to true positive/negative).

More generally, any number of stages may be substituted with equal success. Implementations may use multiple detectors (in sequence or parallel) with different stride classification strengths, scales, and/or vicinities. Each detector may have multiple stages with different classifiers, etc. Each stage may be associated with different classification strengths, scales, and/or vicinities. Various other modifications may be substituted with equal success by artisans of ordinary skill, given the contents of the present disclosure.

While the example discussions are illustrated in the context of a single search, the concepts may be readily extended to multiple searches that operate in parallel or in sequence. For example, a searched image may be divided into multiple parts with different “center” points each of which is handled in parallel with others. As another such example a search may be split into a real-time search and a best-effort search. A real-time search may be subject to scheduling and/or frame rate limitations—these searches may need to complete (or move on) within time constraints. A best-effort search may have more flexibility to scan or re-scan; e.g., a best-effort re-scan may continue a previously terminated search, by resuming the search from the termination point (e.g., at the last searched scale and/or location).

### 2.3 Multiple Detection Integration (MDI) and Early Exit

Object detection frameworks have some degree of spatial tolerance, thus multiple detections for a single object are common even for a single detector. Within the context of the present disclosure, multiple detectors may generate a large number of detections for a single face, this may be further complicated by the differences in sizes, scales, locations, geometries as well as classification strengths, etc. Conceptually, multiple detections that overlap one another are likely to be redundant detections of the same face; in other words, multiple detections may provide an opportunity to reduce redundant operations and save power (early exit). On the other hand, while a single detector may have a false positive rate, a combination of diverse detections is likely to indicate a true hit. In other words, combining multiple detections may provide robust detection.

Exemplary embodiments of the present disclosure use multiple detection integration (MDI) to confirm the presence of a face. Some variants may enable early exit when an exit condition is identified. For example, a detection process may be halted to reduce power (early exit) when a face is identified. Conditions may be based on number of detections, strength of detections, type of detection, etc. Some implementations may enable other entities (e.g., user applications, 3^{rd} party services, etc.) to determine exit conditions; a variety of conditional exit scenarios may be substituted with equal success.

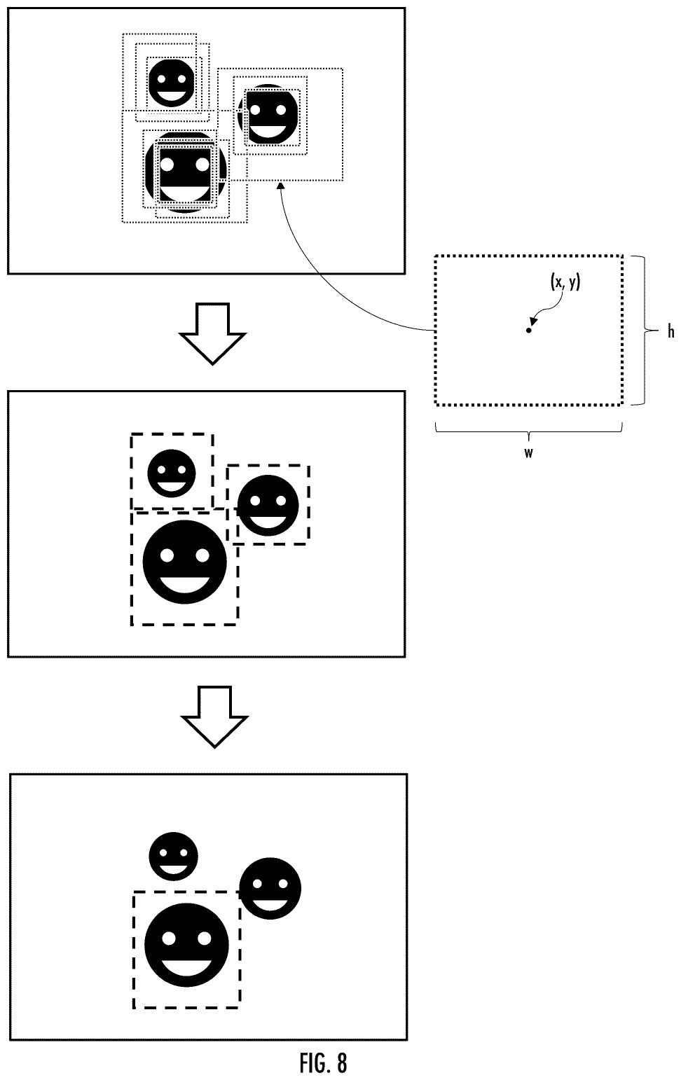

Consider the scenario of FIG. 8 where an image includes multiple detections (N) of a face. To reduce redundant detections, exemplary embodiments of the present disclosure attempt to identify “neighbor” detections which are redundant.

In one exemplary embodiment, each detection is characterized by its detection location (e.g., a location coordinate (x, y)) and sub-window size (e.g., height (h) and width (w)). Other implementations may consider the classification strength and/or relative confidence. For example, detectors that have a higher accuracy and/or a lower false positive rate may be weighted to account for their degree of classification strength. Still other implementations may consider e.g., the number of cascade stages for a detector, the relative size of the detector sub-window, etc.

Identification of neighbor groupings may be performed based on the detection characteristics. For example, detections that occur within a specific distance to one other may be considered neighbors. In one specific implementation, the distance may be based on the relative characteristics of the detections. For example, two detections having the same sub-window size might be identified as neighbors when their coordinate difference is less than half a corresponding sub-window dimension (e.g., difference in x-coordinates is less than half of their width, difference in y-coordinates is less than half of their height, etc.). As another example, two detections having the different sub-window sizes might be identified as neighbors when their coordinate difference is less than half their average sub-window dimension (e.g., difference in x-coordinates is less than half of their averaged width, difference in y-coordinates is less than half of their averaged height, etc.).

More generally, neighboring detections may include any detectors that have similar coordinates and different sizes, transformations, etc. Conceptually, this is because the detection has some amount of spatial tolerance. In other words, differences that are attributed to e.g., size, translation, rotation, scale, etc. may remain in the detection tolerance and should be grouped together. Thus, a first detection at a first rotation at a first coordinate may be combined with a second detection with a second rotation at a second coordinate, so long as the combined difference of the first coordinate and the second coordinate and the first rotational tolerance and second rotational tolerance fall within the detection tolerances. Various other scenarios may be substituted with equal success.

Neighboring detections may be grouped together. Thus, for example, a set of N detections might be distributed into groups of neighbors. Each group may be further characterized by its group numerosity (e.g., the number of detections in the group), group location (e.g., an averaged location coordinate), and group size (e.g., an averaged height and width). In some cases, special handling may be used for groups that have detections that are completely overlapping, e.g., the overlapped detection may be treated as two detections or a single detection (using the overlapping detection, overlapped detection, or an average of the overlapping and overlapped detection characteristics).

In some cases, groups may be ranked according to the number of detections they represent. Depending on how many detections are desired, one or more groups may be returned. For example, if one face detection is desired only the grouping with the largest number of detections may be returned; if two detections are desired, the two highest groupings may be returned, etc.

Exemplary embodiments of the present disclosure may perform multiple detection integration in combination with early exit. Such implementations may start multiple detectors in parallel. However, rather performing an exhaustive search through the entire image for every detection, the detectors may exit detection as soon as a detection count threshold is met for a group. In other words, the MDI process begins grouping neighbors together as they are detected. Once the numerosity for a group exceeds the detection count threshold, the group is returned as a positive detection.

Once an early exit detection is identified, the detector processes may create a keep-out region around the identified group and continue searching for other faces. The keep-out region prevents further unnecessary searches and/or duplicative search results. The detection processes end once the desired number of groups have been returned.

### 3 Object Detection

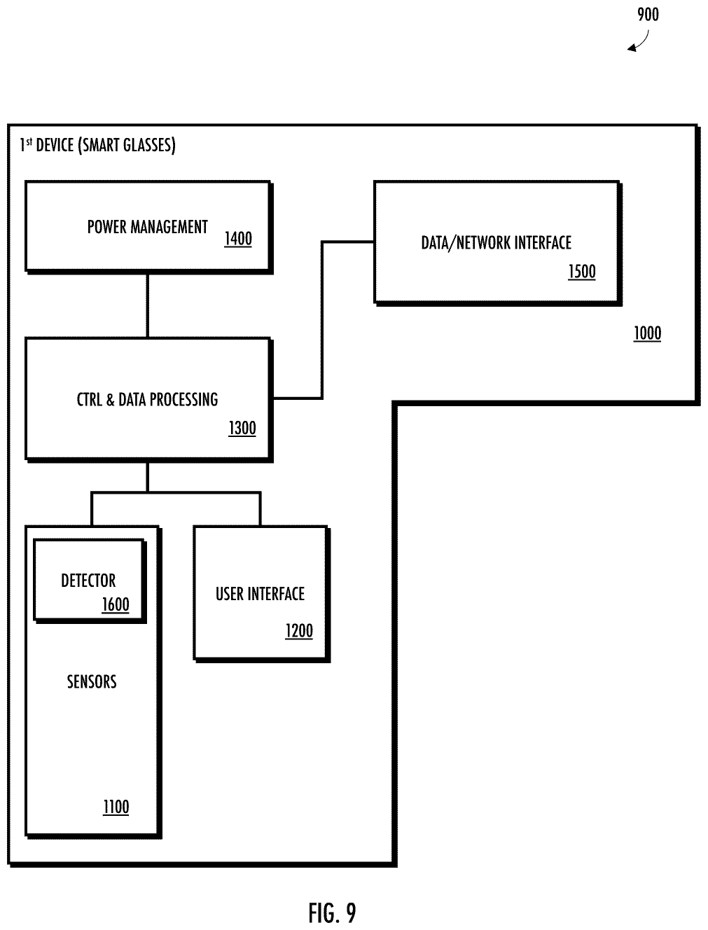

FIG. 9 is a logical block diagram of a user device that is configured to perform object detection. The user device may include a physical frame 1000, a sensor subsystem 1100, a user interest subsystem 1200, a control and data processing logic 1300, a power management subsystem 1400, and a data/network interface 1500, and a detector subsystem 1600.

In one embodiment, the detector subsystem 1600 is implemented as logic that is incorporated within the sensor subsystem 1100. The detector subsystem 1600 may be physically incorporated “on-die”, having direct access to sensed data (e.g., photosites and/or pixels), without incurring wiring loss. Other implementations may locate the detector subsystem 1600 on the control and data processing logic 1300 or standalone configurations. These may be preferred where the control and data subsystem 1300 take a larger role in detection than the sensors, where the detector subsystem 1600 is frequently decoupled from either subsystem, etc. The detector subsystem 1600 may be configured with detection parameters obtained from a training model (discussed elsewhere).

The following examples are discussed in the context of a smart glasses device that detects the presence of objects within the user's environment during an online mode, and an offline training infrastructure that learns object detection parameters. More generally, however, artisans of ordinary skill in the related arts will readily appreciate that the functionalities described herein may be combined, divided, hybridized, and/or augmented within different entities. For example, a likelihood of user interest-based object detection may have broad applicability in smart phones, smart vehicles, smart appliances, etc. Similarly, a device might have both detection and training capabilities—for example, a sufficiently capable smart phone may be capable of both likelihood of user interest-based object detection (online mode) as well as the ability to learn new detection parameters (offline mode).

“Artificial intelligence” (AI) refers to the broad genus of technologies that enable intelligent machines, “machine learning” specifically refers to the subset of AI models that learn from data without explicit programming, and “neural networks” are a specific field of ML implementation that uses a network of “loosely” connected processing nodes to process data. While the following discussions are presented in the context of a neural network, any AI or ML logic implementation may benefit from the techniques described herein.

The physical frame 1000 attaches the device to the user's head. The sensor interface subsystem 1100 monitors the user for user interactions and captures data from the environment. The user interface subsystem 1200 renders data for user consumption and may obtain user inputs. The control and data processing logic 1300 obtains data generated by the user, other devices, and/or captured from the environment, to perform calculations and/or data manipulations. The resulting data may be stored, rendered to the user, transmitted to another party, or otherwise used by the device to carry out its tasks. The power management subsystem 1400 supplies and controls power for the device components. The first data/network interface 1500 converts data for transmission to another device via removeable storage media or some other transmission medium. The detector 1600 is logic configured to detect the presence of objects in sensed data, based on detection parameters.

The various logical subsystems described above may be logically combined, divided, hybridized, and/or augmented within various physical components of the device (or across multiple devices). As but one such example, an eye-tracking camera and forward-facing camera may be implemented as separate, or combined, physical assemblies. As another example, power management may be centralized within a single component or distributed among many different components; similarly, data processing logic may occur in multiple components of the system. More generally, the logical block diagram illustrates the various functional components of the system, which may be physically implemented in a variety of different manners.

While the present discussion describes likelihood of user interest-based object detection, the system may have broad applicability to any object detection application. Such applications may include stationary and/or mobile applications. For example, user interest-based object detection may enable a smart vehicle or kiosk to determine an object (address, signage, obstacle) that the user is likely interested in, and predictively anticipate user queries. Furthermore, the concepts may not be limited to human users, machine “interest” may be substituted with equal success. For example, onboard logic in a surveillance camera may perform localized detection based on other sensor systems (motion detection, infrared, etc.), this may be used to quickly separate between threats and incidental triggers (e.g., a human versus a dog).

The following discussion provides functional descriptions for each of the logical entities of the exemplary system. Artisans of ordinary skill in the related arts will readily appreciate that other logical entities that do the same work in substantially the same way to accomplish the same result are equivalent and may be freely interchanged. A specific discussion of the structural implementations, internal operations, design considerations, and/or alternatives, for each of the logical entities of the exemplary system 900 is separately provided below.

A “physical frame” or a “frame” refers to any physical structure or combination of structures that holds the components of a sensory augmentation device within a fixed location relative to the user's head. While the present disclosure is described in the context of eyewear frames, artisans of ordinary skill in the related arts will readily appreciate that the techniques may be extended to any form of headwear including without limitation: hats, visors, helmets, goggles, and/or headsets. In fact, a physical frame may not hold the user's head at all; the frame may be based on a relatively fixed head positioning determined from a known body position and/or intended use scenario—for example, a heads-up display in a smart car may be trained for the driver's head positioning (or passenger's positioning) to allow for sensory augmentation e.g., during driver operation, etc. As another such example, the components might be mounted-in, or distributed across, other accessories (e.g., necklaces, earrings, hairclips, etc.) that have a relatively fixed positioning relative to the user's head and torso.

As used herein, the term “hands-free” refers to operation of the device without requiring physical contact between the frame and its components, and the user's hands. Examples of physical contact (which are unnecessary during hands-free operation) may include e.g., button presses, physical taps, capacitive sensing, etc.

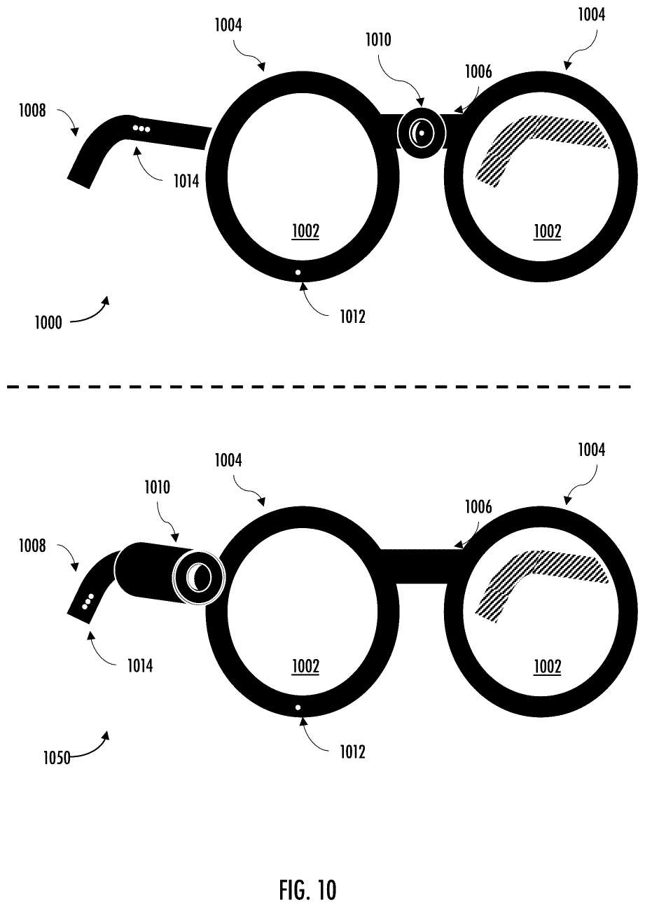

As shown in FIG. 10, the physical frame may be implemented as eyeglass frames that include one or more lenses 1002 housed in rims 1004 that are connected by a bridge 1006. The bridge 1006 rests on the user's nose, and two arms 1008 rest on the user's ears. The frame may hold the various operational components of the smart glasses (e.g., camera(s) 1010, microphone(s) 1012, and speaker(s) 1014) in fixed locations relative to the user's sense/vocal organs (eyes, ears, mouth).

Physical frames may be manufactured in a variety of frame types, materials, and/or shapes. Common frame types include full-rimmed, semi-rimless, rimless, wire, and/or custom bridge (low bridge, high bridge). Full-rimmed glasses have rims that cover the full circumference of the lenses, semi-rimmed have some portion of the lens that expose an edge of the lenses, and rimless/wire glasses do not have any rim around the lenses. Some humans have differently shaped facial features; typically, custom bridge frames are designed to prevent glasses from slipping down certain types of noses. Common frame materials include plastic, acetate, wood, and metals (aluminum, stainless steel, titanium, silver, gold, etc.), and/or combinations of the foregoing. Common shapes include rectangle, oval, round, square, large, horn, brow-line, aviator, cat-eye, oversized and/or geometric shapes.

Larger and more substantial frames and materials may provide stability and/or support for mounting the various components of the device. For example, full-rimmed glasses may support a forward-facing and eye-tracking camera as well as speakers and/or microphone components, etc. Semi-rimmed and rimless/wire form factors may be lighter and/or more comfortable but may limit the capabilities of the glasses—e.g., only a limited resolution forward-facing camera to capture user hand gestures, etc. Similarly, custom bridge frames may provide more stability near the nose; this may be desirable for e.g., a more robust forward-facing camera. Material selection and/or frame types may also have functional considerations for smart glass operation; for example, plastics and woods are insulators and can manage thermal heat well, whereas metals may offer a higher strength to weight ratio.

As a practical matter, the physical frame may have a variety of “wearability” considerations e.g., thermal dissipation, device weight, battery life, etc. Some physical frame effects may be implicitly selected-for by the user. For example, even though customers often consider the physical frame to be a matter of personal style, the new capabilities described throughout may enable active functions that affect a user's experience; in some cases, this may influence the customer to make different selections compared to their non-smart eyewear, or to purchase multiple different smart glasses for different usages. Other physical frame effects may be adjusted based on user-to-frame metadata. In some cases, the user-to-frame metadata may be generated from user-specific calibration, training, and/or user configuration—in some cases, the user-to-frame metadata may be stored in data structures or “profiles”. User-to-frame profiles may be useful to e.g., migrate training between different physical frames, ensure consistent usage experience across different frames, etc.

In one embodiment, the physical frame may center the camera assembly within the bridge 1006, between the user's eyes (e.g., physical frame 1000). A centered placement provides a perspective view that more closely matches the user's natural perspective. However, this may present issues for certain types of lenses which have a long focal length (e.g., telephoto lenses, etc.). In some embodiments, the physical frame may use a “periscope” prism to divert light perpendicular to the capture direction. Periscope prisms insert an additional optical element in the lens assembly and may increase manufacturing costs and/or reduce image quality. In still other embodiments, the camera assembly may be mounted along one or both arms 1008 (see e.g., physical frame 1050). Offset placements allow for a much longer focal length but may induce parallax effects.

More generally, sensory augmentation may affect the physical form factor of the smart glasses. While the foregoing examples are presented in the context of visual augmentation with camera assemblies of different focal length, other forms of sensory augmentation may be substituted with equal success. For example, audio variants may use the frame to support an array of distributed microphones for beamforming, etc. In some cases, the frames may also include directional structures to focus acoustic waves toward the microphones.

The sensor subsystem 1100 may include one or more sensors. A “sensor” refers to any electrical and/or mechanical structure that measures, and records, parameters of the physical environment as analog or digital data. Most consumer electronics devices incorporate multiple different modalities of sensor data; for example, visual data may be captured as images and/or video, audible data may be captured as audio waveforms (or their frequency representations), inertial measurements may be captured as quaternions, Euler angles, or other coordinate-based representations.

While the present disclosure is described in the context of audio data, visual data, and/or IMU data, artisans of ordinary skill in the related arts will readily appreciate that the raw data, metadata, and/or any derived data may be substituted with equal success. For example, an image may be provided along with metadata about the image (e.g., facial coordinates, object coordinates, depth maps, etc.). Post-processing may also yield derived data from raw image data; for example, a neural network may process an image and derive one or more activations (data packets that identify a location of a “spike” activation within the neural network).

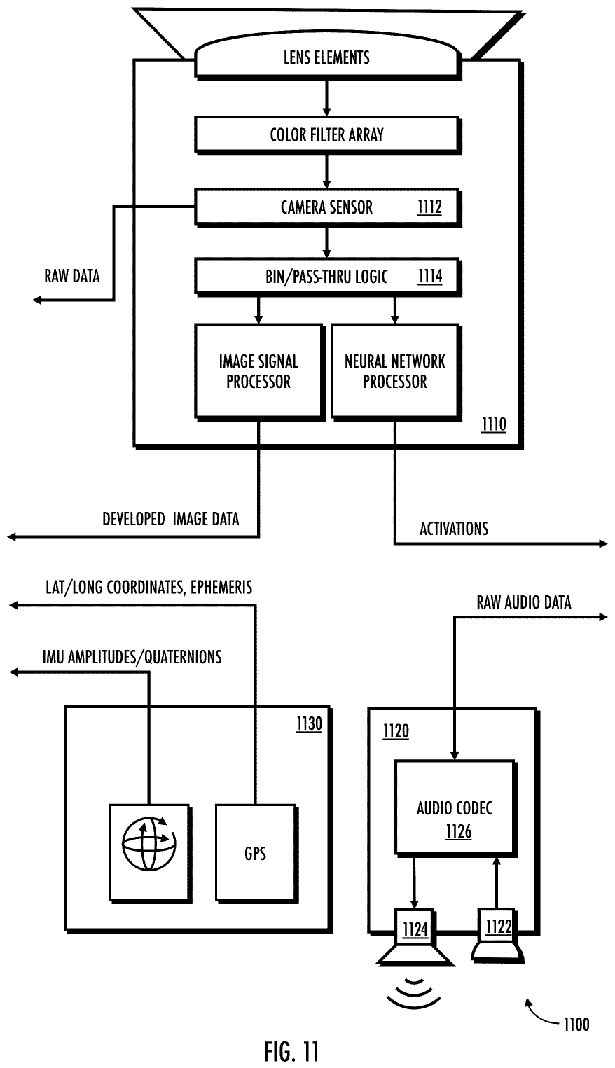

FIG. 11 is a logical block diagram of the various sensors of the sensor subsystem 1100. The sensor subsystem 1100 may include: one or more camera sensor(s) 1110, an audio module 1120, an accelerometer/gyroscope/magnetometer 1130 (also referred to as an inertial measurement unit (IMU)), a display module (not shown), and/or Global Positioning System (GPS) system (not shown). In some embodiments, the sensor subsystem 1100 is an integral part of the device. In other embodiments, the sensor subsystem 1100 may be augmented by the sensor subsystem of another device and/or removably attached components (e.g., smart phones, after market sensors, etc.) The following sections provide detailed descriptions of the individual components of the sensor subsystem 1100.

A camera lens bends (distorts) light to focus on the camera sensor 1112. In one specific implementation, the camera sensor 1112 senses light (luminance) via photoelectric sensors (e.g., photosites). A color filter array (CFA) value provides a color (chrominance) that is associated with each sensor. The combination of each luminance and chrominance value provides a mosaic of discrete red, green, blue value/positions, that may be “demosaiced” to recover a numeric tuple (RGB, CMYK, YUV, YCrCb, etc.) for each pixel of an image. Notably, most imaging formats are defined for the human visual spectrum; however, machine vision may use other variants of light. For example, a computer vision camera might operate on direct raw data from the image sensor with a RCCC (Red Clear Clear Clear) color filter array that provides a higher light intensity than the RGB color filter array used in media application cameras.

In some embodiments, the camera resolution directly corresponds to light information. In other words, the Bayer sensor may match one pixel to a color and light intensity (each pixel corresponds to a photosite). However, in some embodiments, the camera resolution does not directly correspond to light information. Some high-resolution cameras use an N-Bayer sensor that groups four, or even nine, pixels per photosite. During image signal processing, color information is re-distributed across the pixels with a technique called “pixel binning” (see bin/pass-thru logic 1114). Pixel-binning provides better results and versatility than just interpolation/upscaling. For example, a camera can capture high resolution images (e.g., 108 MPixels) in full-light; but in low-light conditions, the camera can emulate a much larger photosite with the same sensor (e.g., grouping pixels in sets of 9 to get a 12 MPixel “nona-binned” resolution). Unfortunately, cramming photosites together can result in “leaks” of light between adjacent pixels (i.e., sensor noise). In other words, smaller sensors and small photosites increase noise and decrease dynamic range.

During operation, the device may make use of multiple camera systems to assess user interactions and the physical environment. In one embodiment, the smart glasses may have one or more forward-facing cameras to capture the user's visual field. In some cases, multiple forward-facing cameras can be used to capture different fields-of-view and/or ranges. For example, a medium range camera might have a horizontal field of view (FOV) of 70°-120° whereas long range cameras may use a FOV of 35°, or less, and have multiple aperture settings. In some cases, a “wide” FOV camera (so-called fisheye lenses provide between 120° and 195°) may be used to capture periphery information.

More generally, however, any camera lens or set of camera lenses may be substituted with equal success for any of the foregoing tasks; including e.g., narrow field-of-view (10° to 90°) and/or stitched variants (e.g., 360° panoramas). While the foregoing techniques are described in the context of perceptible light, the techniques may be applied to other electromagnetic (EM) radiation capture and focus apparatus including without limitation: infrared, ultraviolet, and/or X-ray, etc.

In some embodiments, the camera sensor(s) 1110 may include on-board image signal processing and/or neural network processing. On-board processing may be implemented within the same silicon or on a stacked silicon die (within the same package/module). Silicon and stacked variants reduce power consumption relative to discrete component alternatives that must be connected via external wiring, etc. Processing functionality is discussed elsewhere (see e.g., Classification, further below).

The audio module 1120 typically incorporates a microphone 1122, speaker 1124, and an audio codec 1126. The microphone senses acoustic vibrations and converts the vibrations to an electrical signal (via a transducer, condenser, etc.). The electrical signal is provided to the audio codec, which samples the electrical signal and converts the time domain waveform to its frequency domain representation. Typically, additional filtering and noise reduction may be performed to compensate for microphone characteristics. The resulting audio waveform may be compressed for delivery via any number of audio data formats. To generate audible sound, the audio codec 726 obtains audio data and decodes the data into an electrical signal. The electrical signal can be amplified and used to drive the speaker 1124 to generate acoustic waves.

Commodity audio codecs generally fall into speech codecs and full spectrum codecs. Full spectrum codecs use the modified discrete cosine transform (mDCT) and/or mel-frequency cepstral coefficients (MFCC) to represent the full audible spectrum. Speech codecs reduce coding complexity by leveraging the characteristics of the human auditory/speech system to mimic voice communications. Speech codecs often make significant trade-offs to preserve intelligibility, pleasantness, and/or data transmission considerations (robustness, latency, bandwidth, etc.)

While the illustrated audio module 1120 depicts a single microphone and speaker, an audio module may have any number of microphones and/or speakers. For example, multiple speakers may be used to generate stereo sound and multiple microphones may be used to capture stereo sound. More broadly, any number of individual microphones and/or speakers can be used to constructively and/or destructively combine acoustic waves (also referred to as beamforming).

In some embodiments, the audio module 1120 may include on-board audio processing and/or neural network processing to assist with acoustic analysis and synthesis. On-board processing may be implemented within the same silicon or on a stacked silicon die (within the same package/module). Silicon and stacked variants reduce power consumption relative to discrete component alternatives that must be connected via external wiring, etc. Processing functionality is discussed elsewhere (see e.g., Classification, further below).

The inertial measurement unit (IMU) 1130 includes one or more accelerometers, gyroscopes, and/or magnetometers. Typically, an accelerometer uses a damped mass and spring assembly to measure proper acceleration (i.e., acceleration in its own instantaneous rest frame). In many cases, accelerometers may have a variable frequency response. Most gyroscopes use a rotating mass to measure angular velocity; a MEMS (microelectromechanical) gyroscope may use a pendulum mass to achieve a similar effect by measuring the pendulum's perturbations. Most magnetometers use a ferromagnetic element to measure the vector and strength of a magnetic field; other magnetometers may rely on induced currents and/or pickup coils. The IMU uses the acceleration, angular velocity, and/or magnetic information to calculate quaternions that define the relative motion of an object in four-dimensional (4D) space. Quaternions can be efficiently computed to determine velocity (both head direction and speed).

More generally, however, any scheme for detecting user velocity (direction and speed) may be substituted with equal success for any of the foregoing tasks. Other useful information may include pedometer and/or compass measurements. While the foregoing techniques are described in the context of an inertial measurement unit (IMU) that provides quaternion vectors, artisans of ordinary skill in the related arts will readily appreciate that raw data (acceleration, rotation, magnetic field) and any of their derivatives may be substituted with equal success.

Global Positioning System (GPS) is a satellite-based radio navigation system that allows a user device to triangulate its location anywhere in the world. Each GPS satellite carries very stable atomic clocks that are synchronized with one another and with ground clocks. Any drift from time maintained on the ground is corrected daily. In the same manner, the satellite locations are known with great precision. The satellites continuously broadcast their current position. During operation, GPS receivers attempt to demodulate GPS satellite broadcasts. Since the speed of radio waves is constant and independent of the satellite speed, the time delay between when the satellite transmits a signal and the receiver receives it is proportional to the distance from the satellite to the receiver. Once received, a GPS receiver can triangulate its own four-dimensional position in spacetime based on data received from multiple GPS satellites. At a minimum, four satellites must be in view of the receiver for it to compute four unknown quantities (three position coordinates and the deviation of its own clock from satellite time). In so-called “assisted GPS” implementations, ephemeris data may be downloaded from cellular networks to reduce processing complexity (e.g., the receiver can reduce its search window).

In one embodiment, GPS and/or route information may be used to identify the geographic area that a user has traveled in and/or will pass through. In some cases, this may allow for better predictions as to the current user context (e.g., at home, at work, at the gym, etc.).

In some embodiments, the IMU 1130 may include on-board telemetry processing and/or neural network processing to assist with telemetry analysis and synthesis. Processing functionality is discussed elsewhere (see e.g., Classification, further below).

Functionally, the “user interface” refers to the physical and logical components of the system that interact with the human user. A “physical” user interface refers to electrical and/or mechanical devices that the user physically interacts with. An “augmented reality” user interface refers to a user interface that incorporates an artificial environment that has been overlaid on the user's physical environment. A “virtual reality” user interface refers to a user interface that is entirely constrained within a “virtualized” artificial environment. An “extended reality” user interface refers to any user interface that lies in the spectrum from physical user interfaces to virtual user interfaces.

The user interface subsystem encompasses the visual, audio, and tactile elements of the device that enable a user to interact with it. In addition to physical user interface devices that use physical buttons, switches, and/or sliders to register explicit user input, the user interface subsystem 1200 may also incorporate various components of the sensor subsystem 1100 to sense user interactions. For example, the user interface may include: a display module to present information, eye-tracking camera sensor(s) to monitor gaze fixation, hand-tracking camera sensor(s) to monitor for hand gestures, a speaker to provide audible information, and a microphone to capture voice commands, etc.

The display module (not shown) is an output device for presentation of information in a visual form. Different display configurations may internalize or externalize the display components within the lens. For example, some implementations embed optics or waveguides within the lens and externalize the display as a nearby projector or micro-LEDs. As another such example, there are displays that project images into the eyes.

The display module may be incorporated within the device as a display that overlaps the user's visual field. Examples of such implementations may include so-called “heads up displays” (HUDs) that are integrated within the lenses, or projection/reflection type displays that use the lens components as a display area. Existing integrated display sizes are typically limited to the lens form factor, and thus resolutions may be smaller than handheld devices e.g., 640×320, 1280×640, 1980×1280, etc. For comparison, handheld device resolutions that exceed 2560×1280 are not unusual for smart phones, and tablets can often provide 4K UHD (3840×2160) or better. In some embodiments, the display module may be external to the glasses and remotely managed by the device (e.g., screen casting). For example, the smart glasses can encode a video stream that is sent to a user's smart phone or tablet for display.

The display module may be used where the smart glasses present and provide interaction with text, pictures, and/or AR/XR objects. For example, the AR/XR object may be a virtual keyboard and a virtual mouse. During such operation, the user may invoke a command (e.g., a hand gesture) that causes the smart glasses to present the virtual keyboard for typing by the user. The virtual keyboard is provided by presenting images on the smart glasses such that the user may type without contact to a physical object. One of skill in the art will appreciate that the virtual keyboard (and/or mouse) may be displayed as an overlay on a physical object such as a desk such that the user is technically touching a real-world object, that is, however, not a physical keyboard and/or a physical mouse.

The user interface subsystem may incorporate an “eye-tracking” camera to monitor for gaze fixation (a user interaction event) by tracking saccadic or microsaccadic eye movements. Eye-tracking embodiments may greatly simplify camera operation since the eye-tracking data is primarily captured for standby operation (discussed below). In addition, the smart glasses may incorporate “hand-tracking” or gesture-based inputs. Gesture-based inputs and user interactions are more broadly described within e.g., U.S. patent application Ser. No. 18/061,203 filed Dec. 2, 2022, and entitled “SYSTEMS, APPARATUS, AND METHODS FOR GESTURE-BASED AUGMENTED REALITY, EXTENDED REALITY”, U.S. patent application Ser. No. 18/061,226 filed Dec. 2, 2022, and entitled “SYSTEMS, APPARATUS, AND METHODS FOR GESTURE-BASED AUGMENTED REALITY, EXTENDED REALITY”, and U.S. patent application Ser. No. 18/061,257 filed Dec. 2, 2022, and entitled “SYSTEMS, APPARATUS, AND METHODS FOR GESTURE-BASED AUGMENTED REALITY, EXTENDED REALITY”, previously incorporated by reference in their entireties.

While the present discussion describes eye-tracking and hand-tracking cameras, the techniques are broadly applicable to any outward-facing and inward-facing cameras. As used herein, the term “outward-facing” refers to cameras that capture the surroundings of a user and/or the user's relation relative to the surroundings. For example, a rear outward-facing camera could be used to capture the surroundings behind the user. Such configurations may be useful for gaming applications and/or simultaneous localization and mapping (SLAM-based) applications. As used herein, the term “inward-facing” refers to cameras that capture the user e.g., to infer user interactions, etc.

The user interface subsystem may incorporate microphones to collect the user's vocal instructions as well as the environmental sounds. As previously noted above, the audio module may include on-board audio processing and/or neural network processing to assist with voice analysis and synthesis.

The user interface subsystem may also incorporate speakers to reproduce audio waveforms. In some cases, the speakers may incorporate noise reduction technologies and/or active noise cancelling to cancel out external sounds, creating a quieter listening environment for the user. This may be particularly useful for sensory augmentation in noisy environments, etc.

Referring back to FIG. 9, the power management subsystem 1400 provides power to the system. Typically, power may be sourced from one or more power sources. Examples of power sources may include e.g., disposable and/or rechargeable chemical batteries, charge storage devices (e.g., super/ultra capacitors), and/or power generation devices (e.g., fuel cells, solar cells). Rechargeable power sources may additionally include charging circuitry (e.g., wired charging and/or wireless induction). In some variants, the power management subsystem may additionally include logic to control the thermal exhaust and/or power draw of the power sources for wearable applications.

During operation, the power management subsystem 1400 provides power to the components of the system based on their power state. In one embodiment, the power states may include an “off” or “sleep” state (no power), one or more low-power states, and an “on” state (full power). Transitions between power states may be described as “putting to sleep”, “waking-up”, and their various linguistic derivatives.

As but one such example, a camera sensor's processor may include: an “off” state that is completely unpowered; a “low-power” state that enables power, clocking, and logic to check interrupts; a “on” state that enables image capture. During operation, another processor may “awaken” the camera sensor's processor by providing power via the power management subsystem. After the camera sensor's processor enters its low-power state, it services the interrupt; if a capture is necessary, then the camera sensor's processor may transition from the “low-power” state to its “on” state.

Various other power management subsystems may be substituted with equal success, given the contents of the present disclosure.

Functionally, the data/network interface subsystem 1500 enables communication between devices. For example, smart glasses may communicate with a companion device during operation. The companion device may be a smartphone, a computing device, a computer, a laptop, a server, a smart television, a kiosk, an interactive billboard, etc. In some cases, the system may also need to access remote data (accessed via an intermediary network). For example, a user may want to look up a menu from a QR code (which visually embeds a network URL) or store a captured picture to their social network. In some cases, the user may want to store media to removable data. These transactions may be handled by a data interface and/or a network interface.

The network interface may include both wired interfaces (e.g., Ethernet and USB) and/or wireless interfaces (e.g., cellular, local area network (LAN), personal area network (PAN)) to a communication network. As used herein, a “communication network” refers to an arrangement of logical nodes that enables data communication between endpoints (an endpoint is also a logical node). Each node of the communication network may be addressable by other nodes; typically, a unit of data (a data packet) may be traverse across multiple nodes in “hops” (a segment between two nodes). For example, smart glasses may directly connect, or indirectly tether to another device with access to, the Internet. “Tethering” also known as a “mobile hotspot” allows devices to share an internet connection with other devices. For example, as shown in FIG. 5, a smart phone may use a second network interface to connect to the broader Internet (e.g., 5G/6G cellular); the smart phone may provide a mobile hotspot for a smart glasses device over a first network interface (e.g., Bluetooth/Wi-Fi), etc.

The data interface may include one or more removeable media. Removeable media refers to a memory that may be attached/removed from the system. In some cases, the data interface may map (“mount”) the removable media to the system's internal memory resources to expand the system's operational memory.

Functionally, the control and data subsystem controls the operation of a device and stores and processes data. Logically, the control and data subsystem may be subdivided into a “control path” and a “data path.” The data path is responsible for performing arithmetic and logic operations on data. The data path generally includes registers, arithmetic and logic unit (ALU), and other components that are needed to manipulate data. The data path also includes the memory and input/output (I/O) devices that are used to store and retrieve data. In contrast, the control path controls the flow of instructions and data through the subsystem. The control path usually includes a control unit, that manages a processing state machine (e.g., a program counter which keeps track of the current instruction being executed, instruction register which holds the current instruction being executed, etc.). During operation, the control path generates the signals that manipulate data path operation. The data path performs the necessary operations on the data, and the control path moves on to the next instruction, etc.

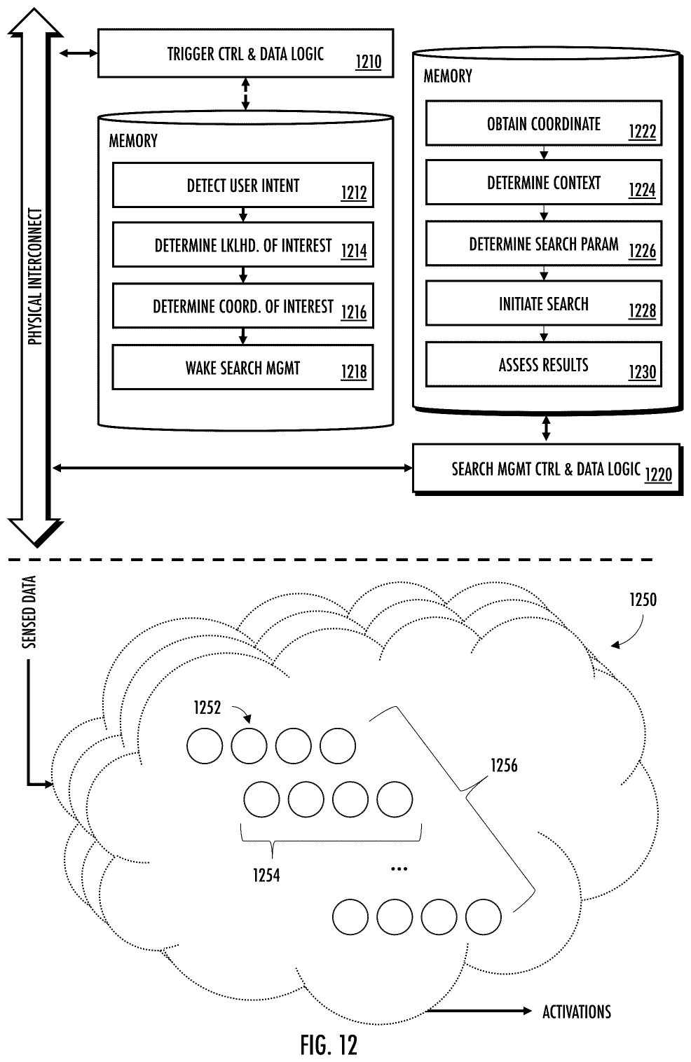

As shown in FIG. 12, the control and data subsystem 1200 may include one or more of: a central processing unit (CPU), a digital signal processor (DSP), a graphics processing unit (GPU), an image signal processor (ISP), one or more neural network processors (NPUs), and their corresponding non-transitory computer-readable media that store program instructions and/or data. In one embodiment, the control and data subsystem includes processing units that execute instructions stored in a non-transitory computer-readable medium (memory). More generally however, other forms of control and/or data may be substituted with equal success, including e.g., neural network processors, dedicated logic (field programmable gate arrays (FPGAs), application specific integrated circuits (ASICs)), and/or other software, firmware, and/or hardware implementations.

As a practical matter, different processor architectures attempt to optimize their designs for their most likely usages. More specialized logic can often result in much higher performance (e.g., by avoiding unnecessary operations, memory accesses, and/or conditional branching). For example, a general-purpose CPU may be primarily used to control device operation and/or perform tasks of arbitrary complexity/best-effort. CPU operations may include, without limitation: operating system (OS) functionality (power management, UX), memory management, gesture-specific tasks, etc. Typically, such CPUs are selected to have relatively short pipelining, longer words (e.g., 32-bit, 64-bit, and/or super-scalar words), and/or addressable space that can access both local cache memory and/or pages of system virtual memory. More directly, a CPU may often switch between tasks, and must account for branch disruption and/or arbitrary memory access.

In contrast, the image signal processor (ISP) performs many of the same tasks repeatedly over a well-defined data structure. Specifically, the ISP maps captured camera sensor data to a color space. ISP operations often include, without limitation: demosaicing, color correction, white balance, and/or autoexposure. Most of these actions may be done with scalar vector-matrix multiplication. Raw image data has a defined size and capture rate (for video) and the ISP operations are performed identically for each pixel; as a result, ISP designs are heavily pipelined (and seldom branch), may incorporate specialized vector-matrix logic, and often rely on reduced addressable space and other task-specific optimizations. ISP designs only need to keep up with the camera sensor output to stay within the real-time budget; thus, ISPs more often benefit from larger register/data structures and do not need parallelization.

Other processor subsystem implementations may multiply, combine, further subdivide, augment, and/or subsume the foregoing functionalities within these or other processing elements. For example, multiple ISPs may be used to service multiple camera sensors. Similarly, neural network functionality (discussed below) may be subsumed with either CPU or ISP operation via software emulation.

The device may include one or more neural network processors (NPUs). Unlike conventional “Turing”-based processor architectures (discussed above), neural network processing emulates a network of connected nodes (also known as “neurons”) that loosely model the neuro-biological functionality found in the human brain. While neural network computing is still in its infancy, such technologies already have great promise for e.g., compute rich, low power, and/or continuous processing applications.

Within the context of the present disclosure, the NPUs may be used to analyze the presence of one or more user interaction(s) at varying levels of confidence. Conventional image processing techniques process the entire image data structure, an NPU may process subsets/aspects of the image data. The computational complexity may be scaled according to the stage (which corresponds to the confidence of detection.) Conceptually, neural network processing uses a collection of small nodes to loosely model the biological behavior of neurons. Each node receives inputs, and generates output, based on a neuron model (usually a rectified linear unit (ReLU), or similar). The nodes are connected to one another at “edges”. Each node and edge are assigned a weight.

Each processor node of a neural network combines its inputs according to a transfer function to generate the outputs. The set of weights can be configured to amplify or dampen the constituent components of its input data. The input-weight products are summed and then the sum is passed through a node's activation function, to determine the size and magnitude of the output data. “Activated” neurons (processor nodes) generate output “activations”. The activation may be fed to another node or result in an action on the environment. Coefficients may be iteratively updated with feedback to amplify inputs that are beneficial, or dampen inputs that are not.

The behavior of the neural network may be modified during an iterative training process by adjusting the node/edge weights to reduce an error gradient. The computational complexity of neural network processing is a function of the number of nodes in the network. Neural networks may be sized (and/or trained) for a variety of different considerations. For example, increasing the number of nodes may improve performance and/or robustness noise rejection whereas reducing the number of nodes may reduce power consumption and/or improve latency.

Many neural network processors emulate the individual neural network nodes as software threads, and large vector-matrix multiply accumulates. A “thread” is the smallest discrete unit of processor utilization that may be scheduled for a core to execute. A thread is characterized by: (i) a set of instructions that is executed by a processor, (ii) a program counter that identifies the current point of execution for the thread, (iii) a stack data structure that temporarily stores thread data, and (iv) registers for storing arguments of opcode execution. Other implementations may use hardware or dedicated logic to implement processor node logic, however neural network processing is still in its infancy (circa 2022) and has not yet become a commoditized semiconductor technology.

As used herein, the term “emulate” and its linguistic derivatives refers to software processes that reproduce the function of an entity based on a processing description. For example, a processor node of a machine learning algorithm may be emulated with “state inputs”, and a “transfer function”, that generate an “action.”

Unlike the Turing-based processor architectures, machine learning algorithms learn a task that is not explicitly described with instructions. In other words, machine learning algorithms seek to create inferences from patterns in data using e.g., statistical models and/or analysis. The inferences may then be used to formulate predicted outputs that can be compared to actual output to generate feedback. Each iteration of inference and feedback is used to improve the underlying statistical models. Since the task is accomplished through dynamic coefficient weighting rather than explicit instructions, machine learning algorithms can change their behavior over time to e.g., improve performance, change tasks, etc.

Typically, machine learning algorithms are “trained” until their predicted outputs match the desired output (to within a threshold similarity). Training is broadly categorized into “offline” training and “online” training. Offline training models are trained once using a static library, whereas online training models are continuously trained on “live” data. Offline training allows for reliable training according to known data and is suitable for well-characterized behaviors. Furthermore, offline training on a single data set can be performed much faster and at a fixed power budget/training time, compared to online training via live data. However, online training may be necessary for applications that must change based on live data and/or where the training data is only partially-characterized/uncharacterized. Many implementations combine offline and online training to e.g., provide accurate initial performance that adjusts to system-specific considerations over time.

In some implementations, the neural network processor may be a standalone component of the system. In such implementations, the neural network processor may translate activation data (e.g., neural network node activity) into data structures that are suitable for system-wide use. Typically, such implementations use a data structure defined according to application programming interfaces (APIs) exposed by other components. Functionally, an API interface allows one program to request/provide a service to another program; while the system allows API calls between separate components, the API framework may be used with equal success within a component. For example, a system-on-a-chip (SoC) may provide the activation data and/or its associated metadata via an API. Some SoC implementations may also provide memory-mapped accessibility for direct data manipulation (e.g., via a CPU).

In some implementations, the NPU may be incorporated within a sensor (e.g., a camera sensor) to process data captured by the sensor. By coupling an NPU closely (on-die) with the sensor, the processing may be performed with lower power demand. In one aspect, the sensor processor may be designed as customized hardware that is dedicated to processing the data necessary to enable interpretation of relatively simple user interaction(s) to enable more elaborate gestures. In some cases, the sensor processor may be coupled to a memory that is configured to provide storage for the data captured and processed by the sensor. The sensor processing memory may be implemented as SRAM, MRAM, registers, or a combination thereof.

Conventional computer vision algorithms generate a post-processed image data (a 2-dimensional array of pixel data) whereas neural network vision/computer vision generates activations. Neural network-based image recognition may have multiple advantages over conventional image recognition techniques. Raw image capture data (e.g., photosite values) are camera-specific i.e., the pixel values are a combination of both the photosite and color-filter array geometry. Raw image capture data cannot be directly displayed to a human as a meaningful image-instead raw image data must be “developed” into standardized display formats (e.g., JPEG, TIFF, MPEG, etc.). The developing process incurs multiple ISP image operations e.g., demosaicing, white balance, color adjustment, etc. In contrast, neural network processing can be trained to use raw image data (e.g., photosite values) as input rather than post-ISP image data (as is done with conventional image recognition techniques). Furthermore, neural network activations represent a node state within the neural network i.e., that the node has accumulated signal potential above a threshold value. If properly trained, neural networks can provide robust detection with very little power. Activation data is both much less frequent, and much more compact, compared to post-processed image/video data.

In some embodiments, an on-chip neural network processing at the sensor and can convey activations off-chip, such as is more generally described within e.g., U.S. patent application Ser. No. 18/061,203 filed Dec. 2, 2022, and entitled “SYSTEMS, APPARATUS, AND METHODS FOR GESTURE-BASED AUGMENTED REALITY, EXTENDED REALITY”, U.S. patent application Ser. No. 18/061,226 filed Dec. 2, 2022, and entitled “SYSTEMS, APPARATUS, AND METHODS FOR GESTURE-BASED AUGMENTED REALITY, EXTENDED REALITY”, and U.S. patent application Ser. No. 18/061,257 filed Dec. 2, 2022, and entitled “SYSTEMS, APPARATUS, AND METHODS FOR GESTURE-BASED AUGMENTED REALITY, EXTENDED REALITY”, previously incorporated by reference in their entireties.

As a related note, a gaze point is a “point” in space, a point/area on a 2D image, or a point/volume in 3D space, to varying degrees of accuracy. Additional processing may be necessary to determine a region-of-interest (ROI), based on the likely object that the user is interested in. Various embodiments of the present disclosure perform ROI determination within on-chip neural network processing at the sensor. In other words, rather than using conventional “pixel-by-pixel” computer vision-based algorithms within a processor, machine learning and sensor technologies are combined to provide region-of-interest (ROI) recognition based on neural network activations at the sensor components—in this manner, only the cropped ROI may be transferred across the bus, processed for objects, stored to memory, etc. Avoiding unnecessary data transfers/manipulations (and greatly reducing data size) across a system bus further reduces power requirements.

As a related tangent, various applications of the present disclosure may have particularly synergistic results from on-chip ROI-determination. For example, long focal length lenses (telephoto lenses) are extremely susceptible to small perturbations and/or variations in fit. In fact, consuming more power to perform ROI-determination on-chip at the sensor may be more efficient and result in lower power downstream compared to other alternatives (e.g., sending incorrect ROI and/or more image data.) While the foregoing discussion is presented in the context of visual data, the concepts are broadly applicable to all sensed modalities (e.g., audio, IMU, etc.). For example, rather than sending a continuous audio file, an audio processor might only send specific audio snippets, or even audio which has been pre-processed.

Application specific integrated circuits (ASICs) and field-programmable gate arrays (FPGAs) are other “dedicated logic” technologies that can provide suitable control and data processing for a smart glasses system. These technologies are based on register-transfer logic (RTL) rather than procedural steps. In other words, RTL describes combinatorial logic, sequential gates, and their interconnections (i.e., its structure) rather than instructions for execution. While dedicated logic can enable much higher performance for mature logic (e.g., 50×+ relative to software alternatives), the structure of dedicated logic cannot be altered at run-time and is considerably less flexible than software.

Application specific integrated circuits (ASICs) directly convert RTL descriptions to combinatorial logic and sequential gates. For example, a 2-input combinatorial logic gate (AND, OR, XOR, etc.) may be implemented by physically arranging 4 transistor logic gates, a flip-flop register may be implemented with 12 transistor logic gates. ASIC layouts are physically etched and doped into silicon substrate; once created, the ASIC functionality cannot be modified. Notably, ASIC designs can be incredibly power-efficient and achieve the highest levels of performance. Unfortunately, the manufacture of ASICs is expensive and cannot be modified after fabrication—as a result, ASIC devices are usually only used in very mature (commodity) designs that compete primarily on price rather than functionality.

FPGAs are designed to be programmed “in-the-field” after manufacturing. FPGAs contain an array of look-up-table (LUT) memories (often referred to as programmable logic blocks) that can be used to emulate a logical gate. As but one such example, a 2-input LUT takes two bits of input which address 4 possible memory locations. By storing “1” into the location of 0 #b′11 and setting all other locations to be “0” the 2-input LUT emulates an AND gate. Conversely, by storing “0” into the location of 0 #b′00 and setting all other locations to be “1” the 2-input LUT emulates an OR gate. In other words, FPGAs implement Boolean logic as memory—any arbitrary logic may be created by interconnecting LUTs (combinatorial logic) to one another along with registers, flip-flops, and/or dedicated memory blocks. LUTs take up substantially more die space than gate-level equivalents; additionally, FPGA-based designs are often only sparsely programmed since the interconnect fabric may limit “fanout.” As a practical matter, an FPGA may offer lower performance than an ASIC (but still better than software equivalents) with substantially larger die size and power consumption. FPGA solutions are often used for limited-run, high performance applications that may evolve over time.

The following discussions provide generalized discussions of various functions and operations that may be implemented within the aforementioned control and data subsystems.

### 3.1 Trigger Logic

Functionally, trigger logic refers to logic that initiates or activates task processing in response to a specific trigger event. Trigger logic may also be used to terminate or disable task processing in response to trigger events. In one embodiment, the trigger logic activates search management logic (discussed below) based on a trigger event.

Trigger events may be sensed from the environment via the sensor subsystem. For example, a camera sensor may capture the user and/or the user's surroundings to detect e.g., motion, lack of motion, etc. Other examples of triggering events may include audible cues (e.g., voice commands, etc.) and/or motion-based cues (e.g., physical gestures). While the foregoing examples are presented in the context of user-generated triggers, machine-generated triggers may be substituted with equal success. For example, trigger events may be received from other devices via the data/network interface; e.g., a remote sensor may capture a trigger and send a message, interrupt, an external server may transmit a trigger message, etc. More generally, any mechanism for obtaining a trigger event may be substituted with equal success.

As a practical matter, trigger logic enables event-based processing; in other words, the search management logic may be kept in lower power states (sleep, deep sleep, off, etc.) until an event occurs. In one specific implementation, the trigger logic may additionally determine initial coordinates for e.g., search. This may further limit the subsequent processing, further reducing power consumption. More broadly, limiting subsequent processing in time and space greatly reduces the amount of data that is processed and/or the processing complexity.

Other benefits for triggering logic and low-power image processing via the use of scalable processing are discussed within U.S. patent application Ser. No. 18/061,203 filed Dec. 2, 2022, and entitled “SYSTEMS, APPARATUS, AND METHODS FOR GESTURE-BASED AUGMENTED REALITY, EXTENDED REALITY”, U.S. patent application Ser. No. 18/061,226 filed Dec. 2, 2022, and entitled “SYSTEMS, APPARATUS, AND METHODS FOR GESTURE-BASED AUGMENTED REALITY, EXTENDED REALITY”, and U.S. patent application Ser. No. 18/061,257 filed Dec. 2, 2022, and entitled “SYSTEMS, APPARATUS, AND METHODS FOR GESTURE-BASED AUGMENTED REALITY, EXTENDED REALITY”, previously incorporated above. As described therein, detection of gestures and other user interactions can be divided into multiple stages. Each stage conditionally enables subsequent stages for more complex processing. By scaling processing complexity at each stage, high complexity processing can be performed on an “as-needed” basis.

Consider the trigger logic implementation of FIG. 12. As shown, a non-transitory computer readable medium includes instructions that, when read from a processor 1210, causes the processor to: detect user intent, determine a likelihood of interest, determine a coordinate of interest, and wake a subsequent search management logic.

At step 1212, the trigger logic detects user intent. The trigger logic may monitor for and/or assess any user interaction that is indicative of the user's intent. For example, eye-tracking cameras may monitor for a user's eye movement activity below a threshold amplitude (e.g., gaze fixation). Gaze fixation may be used, in combination with gaze vectors, to estimate the likelihood of user interest. In other words, a person that has fixated their gaze has a high likelihood of user interest in an object (yet to be identified from a forward-facing camera).

Other indicia of user intent may be used with equal success. For example, forward-facing cameras may monitor the environment—the user's general head direction and movements may be useful to infer user interest. Similarly, the user's hand motions (e.g., pointing and/or other gestures, picking an object up and/or other environmental manipulations, etc.) as well as the user's voice activity may be used to infer user interest. Still other variants may combine and/or hybridize any of the foregoing.

In one embodiment, the trigger logic may be implemented with a subset of sensor capabilities to reduce power consumption of the trigger logic. The capabilities may be reduced by e.g., sensor resolution, sampling rate, post-processing complexity, and/or any other aspect of captured data. For example, an eye-tracking camera may capture images infrequently (2 Hz, 4 Hz, 8 Hz, etc.); similarly, a forward-facing camera may capture images for finger/hand/arm positioning, or a microphone may only be enabled for key word detection, etc. Furthermore, audible and/or visual data may be monitored in its raw sensor formats. For instance, raw image data (photosite values without demosaicing) may be used, audio amplitudes (rather than frequency domain representations) may be used for peak detection, etc.

In some embodiments, different sensor captures may be iteratively launched for varying degrees of detail. Consider one implementation where a low-power “always-on” camera may be used in combination with a high-resolution camera to provide different types of data. Here, the always-on camera may monitor the external environment at very low resolution, very low frame rates, monochrome, etc. to reduce power consumption. The always-on camera may be used in this configuration to assist with auto exposure (AE) for the high-resolution camera; thus, allowing for much faster high-resolution captures. During operation, a set of eye-tracking cameras may monitor the user's eye motions for gaze point (to determine user intent). When user intent is identified, a high-resolution camera capture is performed in the region-of-interest (ROI). In this case however, the low-power always-on camera already has image information in a higher field-of-view; this may be acceptable to get a better context of what is happening without providing a larger higher-resolution ROI. For example, a user may be looking at a table, in their living room (discernable from the always-on camera). The high-resolution ROI may be able to identify the object of interest e.g., key, book, etc. and in some cases may even be able to focus on fine details (text, OCR, etc.). Similar concepts may be extended to other types of media (e.g., high-sample rate snippets of a larger sound recording, etc.).

In some variants, the trigger logic may additionally determine a likelihood of user interest (step 1214). Typically, the user is looking at what they are most interested in-thus, the gaze point is the most likely coordinate of interest, and the surrounding areas are progressively less likely. For example, the foregoing discussions of scanning were described in the context of fixed “center-to-outward” scanning pattern. More generally, however, searching may be more broadly described as moving from the most likely area of user interest, to increasingly less likely areas of user interest. In other words, some embodiments may actively infer a likelihood of user interest, such that searching may proceed in a mapping from most likely to least likely coordinates.

Furthermore, many hands-free user interactions (gaze and/or voice commands) do not have explicit tactile/mechanical user input. User interactions such as gaze fixation and voice commands can be easily confused with ancillary user vision patterns and/or speech, especially for wearable devices that are intended for use across a variety of different circumstances. In other words, user intent may not always correspond to user interest. Thus, the trigger logic may additionally determine whether the user intent has a sufficient likelihood or degree of user interest—an insufficient likelihood would be considered a “false alarm”, that can be ignored to prevent unnecessary searching.

In some embodiments, the trigger logic may create a mapping data structure that identifies coordinates according to their likelihood of user interest. This may be provided to the search management logic to determine whether search is necessary and/or to narrow the search space. Likelihood of interest may be determined based on both the user's behavior as well as the captured environmental data. Here the duration and intensity of user interactions may indicate higher levels of interest (e.g., longer gazes, directed speech and/or gesturing, etc.). Areas less proximate (radiating outwards) may have lower likelihoods. Notably, eye movements are not always centered, thus one or more “hot spots” in the user's field of view may have higher likelihoods of interest.

There are situations where the likelihood of interest is not expressly identified and may be inferred. For example, some devices may not have user input (e.g., surveillance cameras, door cameras, remote sensors, etc.) or may have limited user input. In these implementations, the likelihood of interest may be identified based on the captured data itself—for example, images may be pre-processed to identify salient edges, edge density, color variations, etc.; audio may be pre-processed to identify plosives and formants (indicative of speech, etc.), harmonics, tones, etc.

In some cases, likelihood may further incorporate hysteresis and/or predictive behaviors. Hysteresis increases the likelihood based on previously assessed likelihood-hysteresis may be useful where a user is likely to return to objects of interest. Prediction increases the likelihood based on patterns or models of user behavior. For example, a person that repeatedly looks at the same area may result in increased likelihood of user interest. Similarly, predictive logic may identify certain types of visual patterns, objects, graphic designs, etc. that are likely to correspond to user interest; these may be proactively flagged for subsequent searching.

At step 1216, the trigger logic determines a coordinate of interest. In some embodiments, the coordinate of interest may be the coordinate having the highest likelihood of user interest. In some embodiments, multiple coordinates of interest may be determined. In some variants, a mapping data structure may also be suggested to the search management logic.

In some cases, the coordinate(s) of interest may be determined based on the user's interaction. For example, a simple embodiment might use the center coordinate of the user's field of view as the coordinate of interest. Some variants might attempt to estimate the coordinate of interest based on gaze vectors (e.g., where the user's eye is focused, or eyes converge). Other implementations may identify the positioning of the user's hands or the direction of the user's speech, etc.

In some cases, the trigger logic may also infer additional operational parameters of the search (e.g., search space, numerosity of searches, numerosity of results, etc.). This information may be suggested to subsequent search management logic (as discussed below).

In some cases, the coordinate(s) of interest and/or other search constraints may be determined based on the likelihood of user interest. Conceptually, a person gazing at an object in a relatively blank space (e.g., open sky and terrain) is likely to be focused on the object; thus, the high likelihood of user interest may translate to a small search space around a specific coordinate (e.g., the coordinates of the object). In contrast, a person gazing at a relatively busy field of view (e.g., a crowd of people) may require a much larger search space and/or multiple less confident initial coordinates.

In some cases, the coordinate of interest and/or search space may be selected to avoid the area of the user's interest (keep-out-regions). Keep-out-regions may be useful where an area does not need to be searched; e.g., previously searched areas, duplicative/redundant searches. Keep-out-regions may also be used to avoid duplicating the user's own efforts. For example, a user looking for their keys may be assisted by searching where the user is not already actively looking.

More generally, a variety of suggested search parameters may be inferred from triggering information (e.g., user intent and/or captured environmental data). Such search parameters may include e.g., numerosity of searches, numerosity of results, size of searches, type of searches, keep-out regions, and/or other search space constraints. Here, suggested search parameters may be provided to search management logic; subsequent searches may refine search parameters as more information is known.

At step 1218, the trigger logic wakes the search management logic. In one embodiment, the wake is conditioned upon a sufficiently high likelihood of user interest. In one embodiment, the trigger logic provides the initial coordinate of interest and/or other suggested search parameters to the search management logic as part of, or in addition to, the wake messaging.

In one embodiment, trigger logic and search management logic may be handled within the same subsystem. In other embodiments, the trigger logic and search management logic may be handled within different subsystems that are connected via a physical interconnect. Each subsystem may be separately powered and/or clocked at the component level (e.g., with independent power domain and/or clock domain). Subdividing functions into subsystems may offer several benefits e.g., a wider variety of commodity components that are already available and/or reduced specialty component requirements, simple power management logic within each component, etc. Notably, however, transporting data on/off physical interconnects can be quite inefficient compared to integrated alternatives (e.g., logic integrated within a single silicon substrate).

As previously alluded to, the aforementioned separation of triggering logic from search management logic enables event-based searching. Most conventional computer vision applications use object detection at the start of a processing pipeline e.g., to automate subsequent processing—in other words, object detection is a constantly running background process. In such implementations, the object detection process is at the start of the processing pipeline and is unconstrained (blind detection). In contrast, the trigger logic described above monitors e.g., user interactions and/or environmental information to inform subsequent search management logic. This enables much narrower search spaces, and greatly reduces unnecessary searching.

### 3.2 Search Management

The search management logic handles the control path for searching. Search management logic may define the operational parameters of the search; examples of the operational parameters may include: numerosity of searches, numerosity of results, size of searches, type of searches, staging for searches, start/end/early termination conditions, duration, keep-out, and/or other constraints. In addition to trigger logic, search management logic may additionally incorporate information from other logical entities—for example, a user application may indicate that the user is interested in additional objects, a server application may request additional searches for supplemental information, etc.

While the present disclosure is discussed in the context of object detection (scans) according to a scan pattern, the concepts described throughout may be broadly applied to any process, thread, algorithm, or other logic, which searches within a search space according to constraints. Other examples of computer vision searches may include, without limitation, face/object detection and/or recognition, text recognition, etc. Audio and/or other signal processing searches may use analogous techniques. For example, user interest may be used to search for sound sources for audio beamforming, etc.

As a practical matter, search management logic monitors ongoing searches and adjusts search processing based on searches. In one specific implementation, the search task may be branched, parallelized, sequentially staged, and/or otherwise divided. Dividing the search task into subtasks enables each search task to be individually started, stopped, adjusted, etc. In other words, this enables the search management logic to address different levels of searching complexity within the same overarching framework. Search management logic can throttle up/down processing complexity, as needed. For example, search management logic can perform an early exit based on preliminary search results, to avoid unnecessary further searching. Similarly, search management logic can launch as many (or as few) searches as are necessary. For example, different applications may have different search parameters; a pointed search (where the user is looking at one face), is substantially different than an arbitrary search (where the user is scanning many faces).

Consider the search management logic implementation of FIG. 12. As shown, a non-transitory computer readable medium includes instructions that, when read from a processor 1220, causes the processor to: obtain a search coordinate, determine a search context, determine search parameters based on the search context, initiate a search at the initial search coordinate according to the search parameters, and assess search results.

At step 1222, the search management logic obtains a search coordinate. In some variants, the search management logic may also obtain additional operational parameters of the search (e.g., search space, numerosity of searches, numerosity of results, etc.). Initially, the search management logic may receive the search coordinate and/or additional operational parameters from trigger logic. Since searching may be conducted over multiple iterations, subsequent iterations may refine the search coordinate and/or operational parameters with information from previous iterations. In still other variants, the search management logic may receive search coordinates and/or operational parameters from other logical entities (e.g., a connected smart phone, a 3^{rd} party server, a user application, etc.). In some cases, the user may provide search coordinates and/or search parameters via the user interface (e.g., voice commands, gestures, etc.).

In some cases, multiple search coordinates may be obtained. For example, a user may have gaze fixation at a first coordinate, and hand gestures that identify a second coordinate. In other examples, trigger logic may identify multiple equally likely coordinates of interest.

While the foregoing examples are described in the context of coordinates within an image (a two-dimensional array), other data structures may use other forms of coordinates and/or referential data structures. For example, an audio waveform may use time stamps and/or frequency bands. Multi-dimensional data structures (e.g., images with depth, etc.) may use higher order coordinates.

At step 1224, the search management logic determines a search context. Here, the term “context” broadly refers to a specific collection of circumstances, events, device data, and/or user interactions; context may include spatial information, temporal information, and/or user interaction data.

In some cases, the search context may be explicitly provided. For example, a user may use a gaze point and gesture input to identify a specific type of search, a search coordinate, a field-of-view to search, and/or other search parameters. As another such example, a 3^{rd} party server may wake a user device to capture an image and perform a search at a designated coordinate and/or according to search parameters. Still other implementations may implement retrospective searches. For example, a preliminary search might be performed initially to identify a single object under real-time processing constraints; then later, a retrospective search may be performed to identify all objects with best-effort processing.

In other variants, the search context may be inferred based on the user intent, historic usage, and/or other environmental data. For example, a user's gaze activity may be used to determine whether the user is pointedly fixated on an object or is searching for object(s). Other examples of information that may be useful may include e.g., location data, motion data, and/or active user applications.

At step 1226, the search management logic determines search parameters based on the search context. Different searches may be used for different applications; thus, search context enables the search management logic to identify the appropriate search parameters. In addition to search context, the search management logic may also consider device state (e.g., real-time budget, processing burden, power consumption, thermal load, memory availability, etc.). For example, a device that is running low on resources and/or needs to operate in real-time may need to reduce search complexity; similarly, a device that is idle and/or plugged in may perform more complex (and/or exhaustive) searches.

In one embodiment, the search management logic may determine the numerosity of searches, numerosity of results, size of search space, the size of the sub-window, and/or other spatial constraints. These search parameters are used to configure the data path and its associated data structures. For example, search management logic may determine the number of searches which corresponds to the number of search instances, the size of the search space which corresponds to memory size, and the search type which corresponds to the classifier and sub-window size, etc. As another such example, the search management logic may adjust the relative properties of a strong classifier by allocating greater or fewer weak classifiers; similarly, the relative properties of a detector may be adjusted by changing the cascading of strong classifiers. In other words, search management logic may adjust the detection performance by changing the detector topology.

In one embodiment, the search management logic may determine the staging for searches, start/end/early termination conditions, duration, keep-out, and/or other constraints. These search parameters may be used to configure the control path (e.g., branching conditions, etc.). For example, the search management logic may configure detection to proceed from areas that are most likely to be of interest, to areas that are of lower likelihood (generally, but not necessarily, center-to-outward). In map-based variants, the search management logic may obtain a mapping of likelihood of user interest from earlier stages (e.g., the trigger logic, a previous search iteration, etc.).

In another such example, the search management logic may adjust how search vicinity is refined. For example, “soft” information may be used to identify information that has some uncertainty, probability, or likelihood. Thus, soft information may be used to refine the search vicinity until a hard detection (or hard non-detection) is conclusively determined. This may be used in multiple tiers of detection to refine likelihood of user interest and rapidly iterate toward detections.

Certain types of control path processing may enable and/or disable pre-processing and/or post-processing stages. As but one such example, rotations, scaling, and flipping are pre-processing steps that may greatly improve the accuracy (and/or reduce the complexity) of the data path processing. For example, a neural network may be more easily trained to detect objects with a specific size, orientation, and chirality; handling scaling, rotations, and/or mirroring within pre-processing may allow for less complex neural network processing. As used herein, the terms “pre-processing” and/or “post-processing” refer to relative stages within a data path that is staged into a pipeline. For example, a process may operate on pre-processed data from an earlier pipeline stage.

Various other aspects of data path and/or control path control may be modified based on search parameters and/or search context.

At step 1228, the search management logic initiates a search at the search coordinates according to the search parameters and assesses the search results (step 1230). In one exemplary embodiment, the search management logic may use a dedicated processing subsystem to perform the search operations. Separating data processing in this manner may enable accelerator fabrics and/or other logic. For example, in one specific implementation, classification may be handled within a machine logic fabric (such as neural network fabric, discussed elsewhere).

In some embodiments, the search management logic may re-configure the control path and/or data path based on successful/unsuccessful detections. For example, multiple successful detections may be grouped together based on their relative proximity. This may enable early exit of other detectors. Similarly various stages of detection may be enabled/disabled based on other search conditions being met (e.g., insufficient likelihood, excessive failed search attempts, etc.).

More generally, handling the control path within explicit instructions enables consistent behavior across pre-defined conditions; in contrast, data path processing can use implicitly learned characteristics to provide flexible detection across conditions that are infeasible to enumerate or describe otherwise. In other words, dividing the management and control of searching (control path) from the data processing (data path) allows the search management logic to control a variety of performance characteristics according to application need e.g., search complexity, search time, power consumption, etc.

### 3.2.1 Classification

In one embodiment, the search data path is implemented as classification logic. Classification logic assigns an object to a class based on a set of classification criteria. In one specific implementation, the classification criteria are learned by a training model in offline training and provided to the classification logic for online operation. Here, classification logic is used to perform object detection (i.e., the sub-window is classified as having a face, or null).

While the following discussion is presented in the context of classification, any other matching logic may be used for the search data path processing. Functionally, matching logic determines whether a candidate matches an archetype. In some variants, the matching logic may additionally provide indications of confidence, proximity, distance, and/or direction.

Consider the matching logic implementation of FIG. 12. As shown, a machine logic fabric 1250 (e.g., neural network fabric) comprises logical or physical nodes that are trained into: a plurality of weak classifiers 1252, which are grouped into strong classifiers 1254, which are cascaded into detectors 1256. Other implementations may use other topologies (e.g., cascades of weak classifiers, multiple strong classifiers, etc.). Still other classification logic may be implemented as logical threads, virtual machines, and/or physical hardware. More generally, any classification logic may be substituted with equal success.

In the foregoing discussions, weak classifiers 1252 are configured to provide accuracy that is just above chance (e.g., slightly better than 50% for binary classification). However, combining ensembles of weak classifiers into strong classifiers 1254 compensates for their individual weaknesses, resulting in a strong classifier that outperforms the individual weak classifiers (e.g., predictive accuracy to a specific threshold (usually above 90%)). Detectors may cascade strong classifiers together to adjust false positive/negative rates, further tuning robustness and accuracy.

The foregoing network topology may be efficiently implemented within neural networks, since the network structure and weighting may be described with a finite number of data relationships having a fixed compute time (e.g., a M×N network has at most M×N weights and connections in the forward direction). In contrast, formalized descriptions of equivalent behavior may be substantially more difficult to encode (with more computations, indeterminate branching, and fluctuating memory footprints). In other words, neural networks are structurally efficient for computing and aggregating many computations without interdependency. Neural networks may also be very quickly reconfigured into different topologies. More generally, however, matching logic may be implemented within physical hardware, computer-readable instructions, or any combination of the foregoing with equal success.

In one embodiment, the matching logic obtains sensed data from the sensor subsystem. While the foregoing discussion is presented in the context of images (visible light), other modalities of data may be substituted with equal success. Examples may include acoustic data (audio), electromagnetic radiation (IR, etc.), and/or telemetry information (e.g., inertial measurements), etc. The sensed data may be provided to the neural network according to a data structure (e.g., an array of one or more dimensions, a linked list, a table, etc.).

In one embodiment, the matching logic is configured to determine a match to a first level of accuracy, based on paired data relationships of the data structure of sensed data. In one specific implementation, the paired data relationships are based on learned relationships from a training model. In one specific implementation, the paired data relationships may be between one or more data values (e.g., pairs of one or more pixels/photosites, etc.). The paired data relationships may additionally be combined with other paired data relationships of increasing order to achieve higher orders of accuracy and/or robustness.

In one specific embodiment, the matching logic is based on the data values. Any arithmetic (e.g., sum, difference, weighted sum/difference, etc.), logical (e.g., AND, OR, XOR, NAND, NOR, NXOR, etc.) or other operation may be substituted with equal success.

Notably, learned relationships may be arbitrary in nature. For example, patches may be non-contiguous, overlap, and/or span between scales. While arbitrary data relationships may be inefficiently retrieved a word at a time (for bus accesses), some neural networks may have dedicated memory access that is separate from bus access and avoid its limitations.

In some implementations, sensor-based variants may additionally have sensor-specific geometries (e.g., photosite based coordinates rather than demosaiced pixel coordinates). Unlike computer vision technologies that use post-ISP pixel data, the sensor-based data relationships may be implemented pre-ISP using raw photosite information. This may enable object detection earlier and with compute than post-ISP implementations.

As previously noted, integral image optimizations that trade-off substantial improvements to processing complexity for a larger memory footprint. Notably, larger images require larger integral image accumulators since the accumulated value continues to grow in size. For a neural network, this may result in large data transfers. Various embodiments of the present disclosure may use image scaling and/or binning to reduce the detection window size—e.g., a 31×31 bit detection window may accumulate values below 16 bits to stay within commodity word lengths. In other words, detection window selection may be adjusted to minimize neural network overhead.

In some variants, sensor-based variants may additionally benefit from sensor specific optimizations. Examples may include binning, skipping, and/or sampling optimizations. For example, methods and apparatus for scalable processing are further discussed in U.S. patent application Ser. No. 18/316,181 filed May 11, 2023, and entitled “METHODS AND APPARATUS FOR SCALABLE PROCESSING”, U.S. patent application Ser. No. 18/316,214 filed May 11, 2023, and entitled “METHODS AND APPARATUS FOR SCALABLE PROCESSING”, U.S. patent application Ser. No. 18/316,206 filed May 11, 2023, and entitled “METHODS AND APPARATUS FOR SCALABLE PROCESSING”, previous incorporated above. As described therein, image data may be more efficiently processed at different scales. For example, computer vision processing at a first scale may be used to determine whether subsequent processing with more resolution is helpful. Various embodiments of the present disclosure may readout image data according to different scales; scaled readouts may be processed using scale specific computer vision algorithms to determine next steps. In addition to scaled readouts of image data, some variants may also provide commonly used data and/or implement pre-processing steps.

Conceptually, computer vision processing that is trained on widely available image data (e.g., JPEGs, etc.) is optimized for these encoded formats. Conventional image data is optimized for raster scan displays, rather than the hardware of capture devices. As previously alluded to, object detection may occur quite early in the processing pipeline; potentially without the benefit of ISP e.g., exposure correction, white balance, color correction, etc. In other words, implicitly learned characteristics for feature-based matching may leverage a variety of hardware specific optimizations. Object detection in these preliminary stages may be useful to gate subsequent ISP (e.g., avoiding unnecessary image corrections and processing).

### 4 Classification Training

Functionally, a training model learns a task for another device. As previously noted, artificial intelligence learns to perform a task based on a library of trained data which is then encoded into learned parameters. However, learning is too expensive (e.g., computational burdens, memory footprint, network utilization, etc.) to be feasibly implemented for devices that are intended for real-time and/or embedded applications. Thus, training models are often trained within cloud infrastructure, under best-effort constraints. The resulting parameters may be written to devices which may then execute the learned behavior under operational constraints (e.g., real-time and/or near-real-time applications). For example, patch-based object detection may be learned in the cloud in an “offline” or training phase, and handled on smart glasses in an “online” or inference phase.

Here, cloud services refer to software services that can be provided from remote data centers. Typically, datacenters include resources, a routing infrastructure, and network interfaces. The datacenter's resource subsystem may include its servers, storage, and scheduling/load balancing logic. The routing subsystem may be composed of switches and/or routers. The network interface may be a gateway that is in communication with the broader internet. The cloud service provides an application programming interface (API) that “virtualizes” the data center's resources into discrete units of server time, memory, space, etc. During operation, a client request services that cause the cloud service to instantiate e.g., an amount of compute time on a server within a memory footprint, which is used to handle the requested service.

Referring first to the resource management subsystem, the data center has a number of physical resources (e.g., servers, storage, etc.) that can be allocated to handle service requests. Here, a server refers to a computer system or software application that provides services, resources, or data to other computers, known as clients, over a network. In most modern cloud compute implementations, servers are distinct from storage—e.g., storage refers to a memory footprint that can be allocated to a service.

Within the context of the present disclosure, data center resources may refer to the type and/or number of processing cycles of a server, memory footprint of a disk, data of a network connection, etc. For example, a server may be defined with great specificity e.g., instruction set, processor speed, cores, cache size, pipeline length, etc. Alternatively, servers may be generalized to very gross parameters (e.g., a number of processing cycles, etc.). Similarly, storage may be requested at varying levels of specificity and/or generality (e.g., size, properties, performance (latency, throughput, error rates, etc.)). In some cases, bulk storage may be treated differently than on-chip cache (e.g., L1, L2, L3, etc.).

Referring now to the routing subsystem, this subsystem connects servers to clients and/or other servers via an interconnected network of switches, routers, gateways, etc. A switch is a network device that connects devices within a single network, such as a LAN. It uses medium access control (MAC) addresses to forward data only to the intended recipient device within the network (Layer 2). A router is a network device that connects multiple networks together and directs data packets between them. Routers typically operate at the network layer (Layer 3).

Lastly, the network interface may specify and/or configure the gateway operation. A gateway is a network device that acts as a bridge between different networks, enabling communication and data transfer between them. Gateways are particularly important when the networks use different protocols or architectures. While routers direct traffic within and between networks, gateways translate between different network protocols or architectures—a router that provides protocol translation or other services beyond simple routing may also be considered a gateway.

Various embodiments of the present disclosure provide feature-based libraries to a cloud-based training model to learn features for feature-based detection. In one specific embodiment, the neural network training trains a set of first classifiers having a performance metric above a first threshold. In one embodiment, the set of first classifiers may be trained using e.g., AdaBoost techniques. The set of first classifiers may then be grouped into a set of second classifiers having a performance metric above a second threshold (higher than the first threshold). The set of second classifiers may be arranged to achieve a performance metric above a third threshold. In one specific variant, the arrangement of second classifiers may be based on a cascading topology.

Here, the performance metric may be measured based on a comparison of the expected result to a known result. In other words, the percentage of correct and incorrect results. In some cases, the performance metric may consider both accuracy (true positives, true negatives) as well as robustness (false positives, false negatives).

A variety of different training techniques may be substituted with equal success the foregoing being purely illustrative of the concepts described throughout.

It will be appreciated that the various ones of the foregoing aspects of the present disclosure, or any parts or functions thereof, may be implemented using hardware, software, firmware, tangible, and non-transitory computer-readable or computer usable storage media having instructions stored thereon, or a combination thereof, and may be implemented in one or more computer systems.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. An apparatus, comprising:
a processor; and
a non-transitory computer-readable medium comprising instructions that, when executed by the processor, cause the apparatus to:
obtain an image;
determine a first location to search in the image based on a first object detection likelihood;
perform a first search at the first location via a first detector;
perform a second search at a second location via the first detector, where the second location has a second object detection likelihood; and
where the first object detection likelihood is greater than the second object detection likelihood.

2. The apparatus of claim 1, further comprising a forward-facing camera and an eye-tracking camera and where the image is captured via the forward-facing camera and the first object detection likelihood is based on user interest determined via the eye-tracking camera.

3. The apparatus of claim 1, where the second search is performed in response to the first search having a first soft information level.

4. The apparatus of claim 3, perform a third search at a third location via a second detector different than the first detector and where the third search is performed in response to the second search having a second soft information level greater than the first soft information level.

5. The apparatus of claim 1, perform a third search at a third location via the first detector, where the third location has a third likelihood of user interest, and where the second search and the third search are performed in response to the first search having a first soft information level.

6. The apparatus of claim 5, where the second location and the third location are a first stride length from the first location.

7. The apparatus of claim 6, where the first stride length is based on the first soft information level.

8. A method, comprising:
determining a first location to search in an image based on a first object detection likelihood;
performing a first search at the first location;
determining a second location to search in the image based on a scan pattern; and
performing a second at the second location.

9. The method of claim 8, further comprising capturing the image via a forward-facing camera, and determining the first object detection likelihood based on a gaze point captured via an eye-tracking camera.

10. The method of claim 9, where the scan pattern comprises a center-to-outward spiral pattern.

11. The method of claim 10, where a stride size of the scan pattern is determined based on a detection result of the first search.

12. The method of claim 11, where the first search comprises classifying the first location with a first classifier tier and classifying the first location with a second classifier tier different than the first classifier tier.

13. The method of claim 12, where the first search further comprises classifying the first location with a third classifier tier different than the first classifier tier and the second classifier tier.

14. The method of claim 12, where the first search comprises classifying the second location with the first classifier tier and classifying the second location with the second classifier tier.

15. A machine learning logic comprising a plurality of detectors trained to:
obtain a first location having a first object detection likelihood;
search the first location via a first detector to generate a first detection result; and
determine a second location to search based on the first detection result.

16. The machine learning logic of claim 15, where the second location is further based on a scan pattern.

17. The machine learning logic of claim 16, where the scan pattern comprises a first center-to-outward spiral pattern centered about the first location.

18. The machine learning logic of claim 17, where the plurality of detectors are further trained to:
search the second location via the first detector to generate a second detection result;
determine a third location to search based on the second detection result; and
where the third location is based on a second center-to-outward spiral pattern centered about the second location.

19. The machine learning logic of claim 16, where the first detector comprises at least a first classifier tier and a second classifier tier.

20. The machine learning logic of claim 19, where the first detection result is based on a first result of the first classifier tier and a second result of the second classifier tier.
